(19) United States
(12) Patent Application Publication
(10) Pub. No.: US 2025/0377162 A1
(43) Pub. Date: Dec. 11, 2025

(54) MELTING FURNACE AND METHOD FOR MELTING METAL BY MEANS OF AN ELECTRICALLY HEATABLE IMMERSION HEATING ELEMENT

(71) Applicant: STRIKOWESTOFEN GMBH, Wiehl-Bomig (DE)

(72) Inventors: Rudolf HILLEN, Gummersbach (DE); Florian KULAWIK, Friedberg (DE); Theodoor VAN DER HOEVEN, Pulheim (DE)

(21) Appl. No.: 18/871,836

(22) PCT Filed: Jun. 8, 2023
(86) PCT No.: PCT/EP2023/065403

§ 371 Date: Dec. 5, 2024

(30) Foreign Application Priority Data
Jun. 8, 2022 (DE) 10 2022 205 812.7

(51) Int. Cl. F27B 3/04; F27B 3/08; F27D 1/18; F27D 27/00

(52) U.S. Cl. CPC F27B 3/045; F27B 3/08; F27D 1/1808; F27D 27/00; F27D 2001/1825

(57) ABSTRACT

A melting furnace for melting metal may have a first heating device having at least one electrically heatable immersion heating element. The furnace may also have a circulating arrangement designed to create a flow of molten metal within the melting furnace. A method for melting metal using the melting furnace is also provided.

The invention relates to a melting furnace and a method for melting metal by means of at least one electrically heatable immersion heating element.

Melting furnaces for producing a molten metal from solid metal material are known and widely used. An example can be found in DE 103 25 153 A1. Although these melting furnaces are already in widespread use, there is room for improvement in terms of operating costs and the associated economic efficiency of producing molten metals.

The objective of the present application is therefore to improve the efficiency and in particular the cost-effectiveness of producing molten metals by means of melting furnaces.

This objective is achieved by the subject-matters of the accompanying independent claims. Advantageous developments are disclosed in the dependent claims and in this description.

Accordingly, a melting furnace is disclosed for melting metal, including inter alia:
a first heating device with at least one electrically heatable immersion heating element; and
a circulating device, which is configured to produce a molten metal flow inside the melting furnace.

According to the invention, it has been recognized that the economic efficiency of existing melting furnaces is influenced in particular by the energy sources used and the costs. Until now, gas has been used as the primary energy source for melting metals. The invention moves away from this by instead providing, at least partly, electrical energy as the energy source. Depending on the source of the electrical energy, costs can be potentially lower than in the case of using gas as the energy source.

Furthermore, the invention proposes the use of at least one immersion heating element as an electrically operated heating device. It has been found that such an immersion heating element can achieve a particularly efficient transfer of heat to the metal and thus a particularly effective melting of the metal.

The melting process can also be accelerated by using the circulating device. For example, this can be used to achieve a flow of hot melt around the supplied solid metal, which accelerates the melting of the metal that is still solid. In addition or alternatively, the at least one immersion heating element can be flowed around, as explained in more detail in the following. This improves the transfer of heat from the immersion heating element to or into the molten metal.

The first heating device can comprise at least one control device (for example comprising at least one processor and/or at least one storage device), to control the operation of the immersion heating element. The first heating device can comprise at least one power connection and/or at least one connecting duct to enable it to receive electrical energy. For this purpose, the immersion heating element can be configured to convert the electrical energy into heat energy, for example by dissipating the electrical energy by means of an electrical resistor.

The immersion heating element can be immersed or is immersible into the molten metal which is present or to be produced in the melting furnace, for example along at least half of its length (for example in the case of a maximum filling level). The immersion heating element can generally be elongated and/or cylindrical and/or rod-like.

The immersion heating element can comprise ceramic components, in particular a ceramic outer shell or a ceramic casing. This enables an effective transfer of heat to the surrounding molten metal. The immersion heating element can also be referred to as an immersion heating body or comprise such an immersion heating body. The total power of all immersion heating elements in the melting furnace is at least 50 kW; for melting aluminum alloys, the total power is at least 150 kW.

Where reference is made here to a molten metal provided in the melting furnace, it should be understood that the person skilled in the art can typically clearly deduce the position and extension of the molten metal to be absorbed from the melting furnace. In particular, openings or ducts provided in the melting furnace for conveying the molten metal and/or for supplying material to be melted make it possible to determine the possible extension of the molten metal.

It is also possible to determine a maximum and minimum filling level of the molten metal in the furnace. The minimum filling level is reached for example when the at least one immersion heating element is only immersed into the melt by a minimum permissible immersion length. For example, the minimum permissible immersion length may be no more than one third or no more than one quarter of the theoretically available immersion length or, in other words, the maximum possible immersion length.

On the other hand, a maximum filling level can be determined by areas of the melting furnace which are not supposed to come into contact with molten metal. For example, a height of a charging opening, through which metal to be melted can be added to the melting furnace, but through which no molten metal is intended to flow out of the melting furnace, can determine a maximum possible filling level.

In order to reach the filling level in the melting furnace, at which the immersion heating element is immersed in the melt with its minimum permissible immersion length, the melting furnace can be filled with liquid metal from an external furnace or from a transport ladle or by other means. Such an initial filling of the melting furnace may be necessary before heat can be introduced by the immersion heating element to heat or melt the material for melting. It may also be necessary before the molten metal flow can be produced by the circulating device. For filling the melting furnace with liquid metal a side furnace pocket may be provided which is open at the top and connected to the melting furnace in a fluid-conducting manner.

In order to detect the filling level in the melting furnace, at which the immersion heating element is immersed in the melt by its minimum permissible immersion length, the melting furnace can be provided with one or more level sensors. The terms ‘level’ and ‘filling level’ can be understood to have the same meaning here. A level sensor can detect the minimum permissible level of melt in the melting furnace and then transmit a preferably binary signal to a control unit of the first heating device. The control unit can give permission for the immersion heating element to operate when the minimum permissible level is reached. If the level sensor detects that the minimum level for operating an immersion heating element is not present, for example because metal has been removed from the melting furnace, the permission for operating this immersion heating element is preferably withdrawn. Alternatively, a sensor can measure the level of the melt in the melting furnace and transmit an analogue signal to a control device. Preferably, the control device compares the current level with the minimum permissible level and produces the corresponding signal to enable the operation of the immersion heating element.

If the melting furnace has a second heating device, which is positioned outside the molten metal, the second heating device can be operated, even if the first heating device, namely the immersion heating elements, has not received operating permission from a control unit due to the melt level in the furnace. In the same way, as described above, the maximum filling level of the melting furnace can be detected and a control unit can control the operation of the furnace. For example, at a maximum filling level, the addition of melt can be prevented by the control unit, preventing the opening of each charging door, for example by not giving the drives for opening the doors permission.

According to a preferred embodiment, the immersion heating element can be flowed around by the molten metal flow. In particular, the immersion heating element can be positioned in an area of the melting furnace through which the molten metal flows. In addition or alternatively, it can be immersed in an area of the molten metal in which the molten metal flow is pronounced and for example has a certain minimum velocity. For this purpose, the area can be located in a segment of the furnace with an inflow opening and outflow opening, wherein this furnace segment is flowed through in a defined manner. In other words, the immersion heating element cannot be immersed in a quasistatic area of molten metal or an area in which the molten metal is not flowing at a minimum speed. A plurality of immersion heating elements can be arranged offset to one another in the flow direction so that they obstruct the flow cross-section of the molten metal flow by more than 20%—as viewed from the inflow opening of the chamber.

In particular, the flowing around of the immersion heating element can be understood to mean that the convective heat transfer from the immersion heating element to the molten metal is higher (in particular at least 20% higher, at least 50% higher or at least 80% higher, e.g. approx. 100% higher or more) than the heat transfer from the immersion heating element to non-flowing metal of the same temperature and composition (and thus in particular also the same thermal conductivity).

According to the invention, the melting furnace is provided with at least one charging opening for supplying metal to be melted. The melting furnace can be at least partly (for example with the exception of optional open troughs) closed off from the environment and in particular lined with refractory material. For this purpose, it can comprise a housing and/or wall sections which surround an interior space of the melting furnace in which the molten metal can be received.

The melting furnace can be lined at least partially with refractory material. It can consist of troughs that are open at the top, covered by a removable lid, or it can include such troughs. It may consist of or comprise areas and/or chambers with non-removable ceilings.

The charging opening can define a specific opening in the housing or the wall areas of the melting furnace. It can be adapted to the size of the charging material. The charging opening can be have an area of at least 40 cm²; this may also be 6 m², depending on the size of the charging material (also referred to as the melt). It can be closable, e.g. by means of a door or flap. Metal can enter the melt directly through the charging opening or initially into or onto a charging area of the type explained below.

For example, the charging opening may form a side opening in the melting furnace and/or a non-horizontal opening, which facilitates the introduction of metal and reduces the risk of melt splashing out. For example, the opening cross-section (or a plane in which it extends) can have an inclination to a vertical spatial plane of no more than 45°.

Alternatively, the charging opening can be formed by an open ceiling area of the melting furnace and in particular by a furnace chamber (see definition below), i.e. melt can be supplied for example by opening an upper lid. The charging opening can thus also be horizontal or virtually horizontal and e.g. have an inclination of no more 45° to a horizontal spatial plane. Combinations of differently aligned charging openings (e.g. horizontal and vertical) are also possible.

The melting furnace and in particular a single furnace chamber may have a plurality of charging openings, in particular one large and one small-sized charging opening of the aforementioned kind. This may in particular be a furnace chamber comprising the first or the second heating device.

The charging opening does not necessarily have to be arranged in a furnace chamber
or at least not in a furnace chamber with a first or second heating device. It can also be provided for example in a melt channel with a reduced cross-section between two furnace chambers.

In general, the melting furnace can be configured to melt charging material in the form of a single piece of metal or metal part weighing up to 1200 kg, for which a suitably dimensioned charging opening needs to be provided. The melting furnace may also additionally or alternatively be configured to melt a charging material consisting of a plurality of metal parts that are added to the melting furnace from a collecting container. Also in addition or alternatively, the melting furnace can be configured to melt lumpy charging material. This includes items to be melted which are fed individually into the melt in the furnace, for example in contrast to a collection of several items which are pushed or thrown into the furnace from a container. Alternatively or in addition, the melting furnace can be configured to melt metal shavings. These can also be fed in through a comparatively small charging opening and/or as bulk material.

The molten metal flow can be produced (for example by appropriate positioning and/or operation of the circulating device) and/or the charging opening can be positioned such that the molten metal flow flows from the immersion heating element in the direction of the charging opening. This has the advantage that solid metal supplied through the charging opening is not moved directly towards the immersion heating element by the metal melt flow but possibly away from it. This reduces the risk of a collision of the immersion heating element with the solid metal. For example, in this context there can be a circulating flow path as follows: from the circulating device in the direction of a charging opening, from there to the immersion heating element, and from there back to the circulating device, wherein the length of the flow path from the charging opening to the immersion heating bodies can be longer than the length of the flow path from the circulating device to the charging opening. The latter may include the immersion heating elements not being positioned in the immediate vicinity of the charging opening.

Alternatively or in addition, the molten metal flow can be produced such that it flows onto or around the charging material in the melt. This can be achieved for example by appropriate positioning or alignment relative to a charging opening of the kind mentioned here. The molten metal flow can flow for example below a charging opening and/or directly past it, so that metal added through the charging opening enters the molten metal flow. The flow to and in particular around the charging material accelerates the melting thereof.

In particular, the molten metal flow can flow against at least part of the supplied charging material at a flow speed which corresponds at least to an average flow velocity, in particular at least double the average flow velocity, of the molten metal flow in its circulation in the melting furnace. For this purpose, a cross-sectional narrowing for example of an annular melt channel can be provided in the region of a charging opening.

In general, the circulating device is preferably configured to produce the molten metal flow such that it circulates between the immersion heating element and the circulating device, in particular continuously. The flow velocity can be set to be constant or variable, for example depending on the operating state. In particular, a different and in particular lower flow velocity can be produced in a simple keeping warm operation, in which no solid metal is to be melted, than in a melting operation in which added solid metal is to be melted.

According to a further aspect, the first heating device is positioned in a furnace chamber and the circulating device is optionally positioned outside this furnace chamber, but is connected to it in a fluid-conducting manner. For example, the circulating device can draw molten metal from the furnace chamber via a melt channel or another melt-conducting connection and convey it back into the furnace chamber under pressure (but preferably into a different part of the furnace chamber, e.g. through an inflow opening). Thus, the melt flows preferably to and in particular along a charging opening of the type disclosed herein, before returning back to the first heating device.

A furnace chamber can be understood to be an area of the furnace through which the molten metal flows, which has an inflow and an outflow section (e.g. in the form of an inflow and an outflow opening) and opposite this inflow and outflow section has an expansion of the maximum flow cross-section of at least 20%. The flow cross-sections considered here may refer to cross-sections which can be flowed through defined by the structure, i.e. in other words theoretically or structurally possible flow cross-sections. Alternatively, an actual flow cross-section of the molten metal at the maximum filling level can be considered.

Alternatively or in addition to the aforementioned expansion, the flowed through area may have an increased volume relative to the melt channels connected to the inflow and outflow section (and/or chambers or areas immediately adjoining the latter) of at least 20%, in particular relative to a common unit of volume (for example, volume per meter).

The furnace chamber can be separated from the rest of the furnace and in particular a rest of its melt-carrying inner region by at least one wall. The molten metal can pass through an opening from one furnace chamber to another, in particular forming an inflow area and/or a cross-section reduction of the flow path relative to the furnace chamber. A flow cross-section of the inflow area cannot be more than 80% of a flow cross-section upstream and/or downstream of the inflow area.

A portion of the molten metal received in a furnace chamber can be separated by a technical process from other portions of the molten metal in such a way that a process (e.g. keeping warm or melting process) in the furnace chamber does not directly influence a process outside this furnace chamber. For example, heat generated inside the furnace chamber cannot also have a direct effect outside the furnace chamber, but can essentially only get out of the furnace chamber via the outflowing molten metal.

In the case of a plurality of furnace chambers, these can be separated from one another by at least one wall area (or, in other words, at least one dividing wall). This wall area or this dividing wall can form or comprise for example a wall inside a furnace housing or furnace volume, in particular a vertical and/or upright wall. The molten metal can flow along both sides of this wall. According to this variant, the furnace chambers can each be delimited at least partially by the common wall area. Any furnace chamber described herein may be delimited at least particular by at least one outer wall of the melting furnace, wherein the outer wall can generally define a delimitation to the surroundings of the furnace.

Alternatively, a furnace chamber may comprise its own (e.g. stand-alone) housing and be connected to at least one other housing of the furnace (e.g. again comprising or forming at least one furnace chamber). For this purpose, the furnace chamber may for example comprise a single segment or a single module of the type disclosed herein. This connection can comprise or be in the form of a flow channel, an open channel or a furnace chamber with the dimensions of a flow channel.

Any furnace chamber described herein may be lined with refractory material (i.e. refractory-lined) and for this purpose surrounded by a refractory outer wall (or also housing wall) for example. This outer wall can for example only be perforated locally by a charging opening, an inflow and outflow opening or an optional flue duct.

The furnace chamber can comprise at least 10% of the total furnace volume, in particular if it is a comparatively small dimensioned secondary chamber of a plurality of furnace chambers. Alternatively, the furnace chamber can comprise at least 50% or also at least 70% of the total furnace volume, particularly if it is a comparatively large main chamber out of a possible plurality of furnace chambers. The exact proportion may depend in particular on the total number of furnace chambers provided (for example, the higher the number, the lower the proportion).

In contrast to tubular or upwardly open and generally elongated melt channels, the furnace chamber can be configured to receive the molten metal, forming a large-area melt pool. The area of the melt pool under consideration can be formed by an exposed and in particular horizontal surface of the molten metal. The dimensions of this area can be larger than a cross-sectional area of the melt pool, which includes a vertical spatial axis.

In general, the flow velocities of the molten metal flow can be reduced inside the furnace chamber, for example relative to an inflow velocity and/or an outflow velocity.

Any furnace chamber disclosed herein may optionally be opened. In particular, an upper wall portion or an optional lid of the furnace chamber may be removable.

Any furnace chamber disclosed herein may also be a heated channel (for example, by heating the wall area or radiating the molten metal from vertically above) or unheated channel. This may be the case if the furnace chamber is primarily used to transfer molten metal instead of receiving the molten metal for heating by means of any heating device described herein. However, troughs can also be provided in which melting takes place. A channel can generally be characterized by the fact that a flow cross-section of the furnace downstream and upstream thereof can be at least 50% greater (for example over a length of at least half a meter). The channel can be permanently open at the top or can be at least temporarily closed off by a liftable cover.

According to one embodiment, the circulating device is arranged in another (second) furnace chamber and/or is connected via a melt channel to a (first) furnace chamber, in which the at least one immersion heating element is located. The first furnace chamber can form a main chamber of the furnace with the largest volume. In particular, the first furnace chamber can also comprise a charging opening, but optionally not the circulating device-furnace chamber. Alternatively, the circulating device and the first heating device can be arranged in a common furnace chamber.

According to one further development, the melting furnace comprises a ring channel, which is an annular (metal) melt channel. The heating device and the circulating device are preferably arranged in the ring channel. The ring channel can be accessed through the charging opening and in particular can be charged. The ring channel can define an annular melt receiving area. The ring shape can be circular, elliptical or rectangular with preferably rounded corner areas. However, the ring shape is not limited to any of these variants. The furnace housing of the melting furnace can also be annular; and/or generally shaped to correspond with the ring channel; and/or surround or accommodate the ring channel.

Preferably, the molten metal flow circulates through the ring channel, in particular as an open trough flow.

The ring channel can comprise any furnace chamber mentioned here. In other words, any furnace chamber mentioned here and any other melt-conducting area of the melting furnace can form a segment of the ring channel. Outside the ring channel there may be no molten metal flow in the melting furnace, in particular no continuous and/or circulating molten metal flow.

The melting furnace can have an inner region which is surrounded by the ring channel. In particular, the inner region can be fully surrounded by the ring channel, e.g. along the direction of circulation of the ring channel. As a result, a furnace housing that surrounds the ring channel, can also completely surround the inner region and preferably in a closed manner. The inner region can be open at the top and accessible from there (e.g. by means of ladders, steps or cranes). The inner region can be open and/or define a work surface, e.g. for maintenance work. In particular, it can be free of other furnace components. For example, only components permanently connected to a furnace housing can protrude into the inner region. The inner region can have large enough dimensions that a person can enter it. For example, it can cover an area of at least 1 m² and preferably at least 2 m².

When using the furnace, various operations and actuations can be carried out from an external area, i.e. from sides of the furnace housing which face away from the inner region of the furnace. Such operations carried out from the outside can include in particular, charging the furnace and removing molten metal. In addition or alternatively, these measures can include skimming solid impurities from the surface of the melt, sampling the melt, alloying or refining.

For example, lid-lifting devices with drives, cable ducts and/or electrical terminal boxes can be installed in the inner region, (in other words: electrical fuse boxes or switch boxes). These furnace elements in the inner region do not hinder the measures carried out from the exterior. In particular, access to the melt is unhindered and is not impeded or blocked by furnace elements in the inner region. Conversely, the furnace elements in the inner region are not contaminated or damaged by the work in the exterior area.

The ring channel can comprise a plurality of modules, through which the molten metal flow flows. The modules can be arranged in sequence and/or in a row in a flow direction of the molten metal. The modules can be arranged and connected to one another such that they define the ring channel disclosed herein. Optionally, further modules can also be provided, which for example, enable the melt to be fed to or removed from the ring channel. These modules cannot necessarily be traversed by the circulating molten metal flow, in particular not continuously.

The modules can form parts of the melting furnace which can be handled independently and/or transported independently and/or manufactured independently. They can each comprise at least one portion of a furnace housing. Each module can be supported independently on a base. The modules can contact at least one neighboring module respectively when they are arranged in a row and in particular are connected to it, e.g. by a mechanical connection or by welding. The sequence can be formed in a flow direction of the molten metal flow. Each module can form a portion (in other words: a channel segment) of the ring channel and/or fully form the latter, wherein this portion can extend in the flow direction of the molten metal flow. For example, the portion along the flow direction can have a length of at least 0.5 m.

Each module can comprise at least one inflow opening, preferably exactly one inflow opening, and at least one outflow opening. The at least one inflow opening can be provided for introducing melt from a neighboring module, in particular from an outflow opening of this module, and can preferably be connected to this outflow opening. A further inflow opening can be provided, e.g. for supplying liquid metal into the ring channel. This inflow opening can be connected to or comprise a corresponding supply area. In particular, this further inflow opening can be configured as a branch channel or connected to such a channel in a fluid-conducting manner in order to supply molten metal to the melting furnace. The inflow opening and outflow opening can be located opposite one another in the flow direction of the molten metal flow. The molten metal can flow in through the inflow opening from an upstream module (as viewed in flow direction). The molten metal can flow into a downstream module (as viewed in flow direction) through the outflow opening. Consequently, a module can be flowed through from the inflow opening to the at least one outflow opening. Alternatively, an outflow opening can be configured as a branch channel or connected to such a channel in a fluid-conducting manner, in order to discharge molten metal from the melting furnace.

Each module can be connected to at least two other modules in a fluid-tight manner for transferring the molten metal flow between the modules. Each module can be connected for example to a first module by means of an inflow opening and to a second module by means of an outflow opening. This may apply in particular to modules which together form a ring channel as disclosed here and/or are arranged in series in flow direction. It is not excluded that there may be additional modules (e.g. for the supply of liquid metal or melt extraction), which are connected to only one module but do not themselves form a portion of the ring channel, for example.

For connecting the modules, the flanges of the modules can be screwed to one another, welded or connected in a different way. The connection can be in a sealing manner or sealed. Each module can preferably be connected to any other module. Consequently, the modules can have standardized interface areas for connecting to other modules. The interface areas can for example be characterized by standardized dimensions and/or shapes, in particular by uniform flanges for establishing a connection with other modules.

The modules can only be connected to one another at least partly at the final installation site, which is where the melting furnace is used. This facilitates the transport of the melting furnace to the installation site. In particular, the modules can have dimensions which are suitable for standard loading volumes of trucks or shipping containers, in order to facilitate their transport. For example, the modules can have a cross-sectional area, as a product of width and height, of less than 12 m² for road transport or less than 7.2 m² for transport by sea containers.

Each module can comprise a furnace housing, in particular made of steel. Each module can be lined with refractory material or, in other words, be refractory-lined. This lining is preferably performed, namely for cost reasons, before the module is set up at the installation site of the melting furnace and/or before the module is installed to produce a melting furnace. For example, already cured linings can be installed in the modules or cured or dried in the modules before these modules are set up at the installation site of the melting furnace and connected to one another. This reduces the required heating of the melting furnace during the initial start-up phase at the installation site. Alternatively, the modules can only be lined with refractory material at the installation site, for example with a cured or uncured lining. The refractory linings of interconnected modules can also be connected to one another and/or added to form a continuous lining.

The modules can be combined in a flexible manner to form a melting furnace, for example in consideration of the desired capacity of the melting furnace. In principle, several different melting furnaces can be produced from a group of modules by selecting and combining the modules. This reduces the manufacturing costs of a respective melting furnace. As explained below, the provision of at least two modules has particular advantages in terms of reduced transport costs. A higher number of modules, in particular at least four, means that it is possible for modules for producing different layouts of a melting furnace can be arranged and connected in different ways. For example, a module sequence along the metal flow axis can be varied to produce different layouts.

Accordingly, according to an advantageous embodiment, the modules can be used in different layouts or designs of a melting furnace or, in other words, assembled and connected according to such different layouts or designs. In other words: the modules are preferably configured such that different features and/or capabilities of the melting furnace can be achieved by different combinations or different sequences of the modules. For example, by varying the number of modules different furnace sizes or different furnace capacities can be produced with limited cost. For example, the melting capacity of the melting furnace can be varied by varying the number of modules in which immersion heating elements are arranged. For example, the melting furnace can be easily adapted to the metal to be melted by varying the number of modules with a charging area.

The melting furnace can be formed completely from modules of the type disclosed here. A module can be configured according to any of the following examples and a melting furnace may comprise any combination and number of modules according to the following examples: module with circulation pump; module with charging opening; module with opening for scraping the melt surface (comparable to or comprising a impurity collection chamber disclosed herein); module with immersion heating elements; module for molten metal extraction. According to one embodiment, the melting furnace comprises respectively at least one module according the examples listed above, wherein in particular the module with an opening for scraping the melt surface can be omitted. Furthermore, instead of a separate module for molten metal extraction, one module, which preferably defines a section of a ring channel disclosed here, can comprise a conventional tapping valve. In principle, one module can also embody or comprise two of these examples, for example by comprising both a circulation pump and immersion heating elements.

According to one further development, the following applies to the dimensions of each module or at least a plurality of modules:
the height is less than or equal to 2.9 m (in particular for transport in a sea container) or the height is less than or equal to 3.8 m (in particular for road transport); and/or
at least one first (e.g. shorter) horizontal dimension is less than or equal to 2.5 m (in particular for transport in a sea container) or is less than or equal to 3 m (in particular for road transport); and/or
at least one second (e.g. longer) horizontal dimension is less than or equal to 6 m or is less than or equal to 13.6 m.

For example, the first horizontal dimension can be a width and/or the second horizontal dimension can be a length. The first and second horizontal dimension can extend substantially or completely orthogonal to one another.

For example, one module with an opening for receiving scrap components or recycling material from a shaping process for the purpose of remelting can be larger than a plurality of or all other modules. This module can be dimensioned for transport by road and/or can reach or exceed the upper limits defined above (and/or in particular exceed the lower limits). All of the other modules may however reach the lower limits defined above.

The modules can have a connecting area at the at least one inflow opening and/or at the at least one outflow opening, by means of which they can be connected to any other module. This connecting area can be e.g. a flange or interface area of the type discussed above. This can be provided in particular in the context of variants in which, in the manner described above, the modules each comprise a furnace housing which is lined with refractory material.

In a simple case the melting furnace only comprises two modules, in which the melt still circulates in a circle in a ring channel formed by the modules. Each module has a connecting area, e.g. a flange, at its inflow and at its outflow opening. The flanges are preferably located on the longitudinal side of the modules (e.g. a comparatively longer or a longest outer side of the modules), so that the modules are only about half as wide for transport as the melting furnace after the modules have been connected at the installation site. The width of the modules is then for example less than the aforementioned 2.5 m for transport in sea containers, while the melting furnace assembled from the modules is wider than 2.5 m.

With this melting furnace, the melting furnace can be easily enlarged or extended by adding further modules between the two modules described above. For example, the melting capacity of the melting furnace can be increased by adding each module with immersion heating elements. The melting capacity can be increased as required by adding further modules with immersion heating elements.

In a further embodiment, the circulating device comprises a mechanical or electromagnetic pump and the molten metal flows from a pressure side to an intake side of the pump as part of its circulation.

According to a further embodiment, the heating device is arranged in a section of the annular channel in which an essentially complete volume exchange of the molten metal takes place as a result of the molten metal flow. This volume exchange preferably takes place continuously, in particular by correspondingly continuous flow through the said section. In other words, no volume fractions of the molten metal flow can remain permanently in this section and/or flow through this section at a significantly reduced speed (for example, at a speed of less than half of a maximum flow speed of the molten metal flow in this section). The molten metal can flow continuously and completely through the section with the heating device, so that a correspondingly high volume of the molten metal is heated by the heating device. In particular, the section comprising the heating device can be free of protrusions directed towards a channel center and/or free of undercuts. Such features could otherwise impede the preferably complete exchange of molten metal when flowing through this section.

In addition or as an alternative, the heating device (and/or the section immediately upstream of it) can be used to ensure that the molten metal flow exhibits a substantially uniform (or constant) flow velocity in cross-section. In particular, a velocity profile within this cross-section may show deviations between a maximum and minimum velocity of no more than 25%. Direct contact areas between the molten metal and the inner walls of the melting furnace and/or the annular channel cannot be taken into consideration.

According to a further embodiment, the heating device comprises a plurality of immersion heating elements, wherein each immersion heating element is arranged at least partially outside flow shadows of at least one corresponding other immersion heating element (or of the at least one other immersion heating element). In particular, each immersion heating element can be arranged at least outside a direct flow shadow of at least one or all of the other immersion heating elements.

The flow shadow of an immersion heating element can form or encompass an area into which molten metal cannot pass through the immersion heating element without deflection (in particular a deflection along its outer side). Viewed in a flow direction of the molten metal, flow impinging on an immersion heating element, the flow shadow can be arranged on a rear side of the immersion heating element. In contrast, the molten metal flow can hit the immersion heating element at the front. The flow shadow can comprise a virtual extension of a flow axis of the molten metal flow impinging on the immersion heating element, whereby this extension intersects the immersion heating element.

At least half, at least two thirds and preferably the entire surface of each immersion heating element immersed in the molten metal can be outside the aforementioned flow shadow. In order to be arranged outside the flow shadow of another immersion heating element, an immersion heating element (preferably each immersion heating element) can be offset transversely to the direction of flow of the molten metal flow relative to the corresponding other immersion heating element, in particular at least partially or completely.

According to one further development, the melting furnace comprises at least one second heating device, which is positioned or can be positioned outside the molten metal. The second heating device is preferably set up to supply heat to the molten metal and/or a metal to be melted. In the latter case, for the purpose of this heat supply, it can be positioned close to and in particular vertically higher than a charging opening or an optional charging area described below, which can be in the form of a charging ramp in particular. However, it can be positioned at a horizontal distance from the charging opening and in particular positioned behind the charging opening when viewed in the flow direction. Alternatively, it can be positioned directly opposite and above the optional charging ramp.

The provision of a second heating device can improve the efficiency of the melting furnace. This allows the molten metal to be heated when it is located away from the at least one immersion heating element. Excessive cooling of the molten metal, in particular the circulating molten metal, after optional flowing around the immersion heating element can thus be prevented, which enables a lower-power operation of the immersion heating element. The second heating device can be arranged in a furnace area which is already required for the operation of the furnace, in which the provision of immersion heating elements is not necessarily preferred, for example near a charging opening.

The first and second heating device can be spaced apart from one another, as viewed along the flow path of the molten metal. The first heating device can be configured for example can be configured to produce sufficient heat to melt the metal. The second heating device however cannot be configured to produce such a high level of heat. Instead, it can produce a lower amount of heat which is still sufficient to keep the molten metal warm (in particular to keep it molten).

The first and second heating device can be generically different, for example based on different operating principles for heat generation and/or heat transfer. In particular, the first heating device and the second heating device can be configured to produce heat independently of one another. In addition or alternatively, they can be controlled and/or operated independently of one another with respect to their respective heat production. According to one variant, the second heating device and the first heating device comprise heat sources that can be operated independently of one another. Optionally, both the first and the second heating device can be operated electrically or, in other words, convert electrical energy into thermal energy. Preferably, the first heating device transfers at least 50% of the energy required for melting into the metal and preferably more than this 50%. However, the second heating device preferably transfers less than 50% of this energy required for melting.

In particular, the second heating device can be configured as a radiant heater or also in particular as a ceiling radiator (or ceiling heater) or can comprise at least one such radiator. The latter can be opposite the molten metal and/or be directed towards it. The radiant heater can be electrically operated. The radiant ceiling heater can be arranged in a ceiling area of the melting furnace, in particular on an inner ceiling extending essentially parallel to the molten metal. The ceiling area can be fixed or, in other words, cannot be opened.

In general, the heating device can comprise at least one heating element which radiates the surface of the molten metal from above and thereby heats it, in particular wherein more than 50% of the heat transfer into or onto the melt is by radiation. According to one variant, the heating element is elongated and/or rod-shaped and/or cylindrical. For example, it can be an SiC heating rod which is arranged horizontal and/or parallel to the surface of the molten metal. With a plurality of heating elements and in particular heating rods, these can be arranged in a common plane. This can in turn extend horizontally and/or parallel to the surface of the molten metal.

Alternatively, the second heating device can comprise at least one gas burner. In particular, this can be configured and positioned to heat a still solid metal in a charging area or to heat the molten metal. A plurality of second heating devices can also be provided, wherein these heating devices can also differ from one another. For example, the melting furnace can comprise both a radiant heater (in particular a ceiling heater) and a gas burner.

The radiant heater can enable efficient continuous operation and in particular help to keep the molten metal at a desired temperature. A gas burner can enable a particularly rapid heating of solid metal before it is supplied to the molten metal, but can also reliably heat molten metal that is already present.

According to one variant, the second heating device is arranged to be vertically higher than the immersion heating element. This allows the reliable heating of the molten metal, without the second heating device having to be immersed therein. In particular, the second heating device can be arranged vertically above a maximum possible filling level.

In one embodiment, the second heating device is arranged at least at the same vertical height or vertically higher than a charging opening and in particular any charging opening of the melting furnace. This ensures a particularly reliable positioning of the second heating device outside the molten metal.

According to a further aspect, the circulating device, as already mentioned above, comprises a mechanical or electromagnetic pump or, alternatively, a magnetic or electromagnetic stirrer. The magnetic or electromagnetic stirrer can be arranged outside the melting furnace and/or a housing or a furnace chamber. At least one part of the stirrer (e.g. a magnetic or electromagnetic drive device) may be arranged for example underneath a furnace chamber or a furnace housing.

According to an alternative or additional embodiment, the circulating device comprises a mechanically driven stirrer as an example of a mechanical pump. In this case for example a stirring element extending into the melt can be rotated by mechanical coupling to a drive motor.

A preferred circulating device is a mechanical or electromagnetic pump.

According to one further development, the second heating device and the first heating device are arranged in different furnace chambers. As explained above, these different furnace chambers can be separated e.g. by at least one wall, one further furnace chamber or another area which can be flowed through or around. Preferably, the furnace chamber (also referred to in the following as the first furnace chamber), which comprises the first heating device, has a smaller (e.g. average or maximum) flow cross-section than the other furnace chamber (also referred to in the following as the second furnace chamber), which comprises the second heating device. For example, the (e.g. average or maximum) flow cross-section of the first furnace chamber may have no more than 80% or also no more than 50% of the (e.g. average or maximum) flow cross-section of the second furnace chamber. In this way a desired flowing around of the at least one immersion heating element can be achieved. On the other hand, the surface area of the molten metal in the second furnace chamber can be increased in a targeted manner for the effective transfer of heat by the second heating device, which is positioned outside the melt.

According to one aspect, the second heating device is arranged in a (second) furnace chamber of the melting furnace, which has a charging opening for supplying metal to be melted. This can also be the only charging opening of the melting furnace or also one of a plurality of charging openings of the melting furnace. In the latter case, this is preferably not the smallest charging opening of the melting furnace, but for example the largest or at least one of above-average size.

In this way, comparatively large-volume metal parts to be melted can be fed into the second furnace chamber and melted there before they reach the immersion heating element in the other (first) furnace chamber. This reduces the risk of a collision between solid metal parts and the immersion heating element.

According to one aspect, the second furnace chamber has a charging opening, which is larger than the first charging opening or than the charging opening in the first furnace chamber.

In general, a cross-section of the inflow area to the furnace chamber, which comprises the second heating device, can be smaller than the cross-section of an outflow section of this furnace chamber. In this way, flow velocities near the inflow area can be increased and the solid meal parts there can be flowed around fully and with a high transfer of heat per unit of time.

Furthermore, the inflow area of the furnace chamber, which comprises the second heating device, can be closer to the charging opening of this furnace chamber (also referred to here as the second charging opening) than the outflow area of this chamber. This proximity can be measured along a flow path and in particular as a distance along this flow path. This can also ensure that supplied metal parts are exposed to high flow velocities and are melted correspondingly quickly.

In this connection it may also be provided that the (first) furnace chamber, in which the first heating device is arranged has a smaller sized charging opening than the charging opening of that furnace chamber (second furnace chamber), in which the second heating device is arranged. Both furnace chambers can therefore comprise charging openings, but the furnace chamber with the first heating device has one with smaller dimensions, so that for example only metal parts with smaller dimensions can be supplied there. This also helps to minimize the risk of damage to the immersion heating element by solid metal. In particular, an opening cross-section of the charging opening in the first furnace chamber can be less than half the size or less than a tenth or less than a hundredth of the opening cross-section of the charging opening in the second furnace chamber.

According to a further development the molten metal flow can be produced such that (e.g. by suitable positioning and/or alignment of the circulating device) it flows from an outflow area of the (first) furnace chamber, which comprises the first heating device, in the direction of an inflow area of the (second) furnace chamber which comprises the second heating device. Furthermore, it can flow from an outflow area of the second furnace chamber in the direction of an inflow area of the first furnace chamber. This represents an advantageous direction of circulation of the molten metal, to ensure effective melting of metal with a low risk of damage to the immersion heating element caused by collisions with solid components.

In general, the circulating device can draw molten metal from the first furnace chamber and convey it into the second furnace chamber. Alternatively, the circulating device can draw molten metal from the second furnace chamber and convey it to the first furnace chamber.

In one embodiment the circulating device is positioned close to an inflow area of the furnace chamber which comprises the second heating device, and/or opens into this inflow area, in particular wherein the circulating device is positioned outside the furnace chamber which comprises the second heating device. As a result, solid metal supplied into the second furnace chamber can be circulated at high pressures and/or high speeds, which enables rapid melting. On the other hand, the risk can be reduced that the circulating device circulates molten metal containing solid components, which reduces a corresponding risk of damage to the circulating device. In principle, it can be provided that solid material supplied to the first furnace chamber can also be circulated at high pressures.

According to one embodiment, the circulating device is arranged in the furnace chamber which comprises the first heating device. It can however also be positioned outside of this, for example in a separate furnace chamber, but preferably not in the furnace chamber with the second heating device.

According to a further variant, the molten metal flow can be produced such that it flows from the first heating device in the direction of the circulating device and from the circulating device in the direction of the second heating device. This can support the melting of solid components in the molten metal kept warm by the second heating device before they reach the first heating device.

According to a further variant, the molten metal flow can be produced such it flows from the first heating device in the direction of the circulating device and from the circulating device in the direction of a charging opening of the second furnace chamber (second charging opening). This can support the melting of solid components in the furnace chamber with the second charging opening and make the second heating device superfluous due the convective heat transport.

The melting furnace can comprise at least one impurity collection chamber through which the molten metal flow can flow, inside which impurities contained in the molten metal can be collected. Furthermore, the impurity collection chamber can make it possible to remove the collected impurities or drain them, in particular via an opened upper side, an openable lid, an openable door or an outflow valve. According to one variant, the impurity collection chamber has an outflow valve for example which can be opened to allow impurities deposited in the base area to flow out (or be drained).

The impurity collection chamber can be positioned between the second furnace chamber, which comprises the second heating device and/or a second charging opening, and the first furnace chamber, which comprises the first heating device, when viewed in the direction of flow of the molten metal. In melting furnaces with a charging opening, the impurity collection chamber—viewed in the direction of flow—is preferably arranged downstream of the charging opening and/or its charging area (in particular, viewed along the flow path, closer to the charging opening than to the closest of the first and second heating device viewed in the direction of flow). In melting furnaces with multiple charging openings, the impurity collecting chamber—viewed in the direction of flow and in particular starting from the first heating device—is preferably arranged downstream of one or more of these charging openings and/or their charging areas (in particular viewed along the flow path, closer to the charging opening than to the nearest of the first and second heating device viewed in the direction of flow).

In particular, a volume of molten metal can flow through the impurity collection chamber before it enters the first furnace chamber. Thus, impurities can be retained within the impurity collection chamber before they can adhere to or otherwise damage the immersion heating elements.

In addition or alternatively, the impurity collection chamber may have an inflow section and an outflow section and a bottom section which is lowered at least relative to the outflow section (or, in other words, a vertically recessed section or also a bottom depression) for collecting impurities settling there. Impurities in the incoming molten metal can thus sink into the bottom depression, in particular as this depression can cause a local reduction in the flow velocity.

The inflow area can have an opening cross-section that extends to a bottom region of a furnace chamber which is located upstream of the impurity collection chamber. This oven chamber can be, for example, the first or second oven chamber.

Alternatively, the impurity collection chamber may comprise a device (for example in the form of a surface weir) for collecting impurities floating on or near the surface. This device can be comb-like and/or filter-like and/or steplike and the molten metal can flow over or through it. The device can generally be configured to retain impurities floating on or near the surface. These can then be removed from the device and thus from the melting furnace.

A impurity collection chamber for collecting impurities floating on or near the surface may have an inflow area and an outflow area, the outflow area being positioned lower than the inflow area with respect to a vertical spatial direction. This can cause the impurities to float on the surface within the impurity collection chamber over as large an area as possible and for a long period of time and can therefore be collected and removed with a correspondingly increased reliability.

Consequently, one embodiment provides for the impurity collection chamber to have an outflow area with an opening cross-section, wherein an upper edge of the opening cross-section is lower than a minimum permissible level (k-min) of the molten metal in a furnace chamber located (in particular directly) upstream relative to the impurity collection chamber. Furthermore, the inflow area can have an opening cross-section whose upper edge is higher than a maximum permissible level (k-max) of the molten metal in the aforementioned upstream chamber.

For any impurity collection chamber, in order to ensure an effective cleaning function, its inflow area may be closer to a charging opening than its outflow area.

In one embodiment, the melting furnace comprises a first impurity collection chamber of the type described above with a recessed bottom region for collecting impurities floating in the molten metal. In addition, this melting furnace also comprises an impurity collection chamber for collecting impurities of the type described above floating on the surface. The first and second impurity collecting chambers are preferably flowed through in succession by the molten metal flow. The molten metal flow can preferably flow through the first and second impurity collection chambers in succession. Alternatively, the two embodiments of the impurity collection chambers are combined in one chamber. In particular, these two impurity collection chambers can be positioned between the second and the first furnace chamber when viewed along the direction of flow.

In a further embodiment, the melting furnace has a charging area which is positioned or can be positioned outside the molten metal and is configured to receive metal to be melted, in particular wherein the charging area is inclined in the form of a ramp, for example vertically downwards and/or in the direction of a base area of the melting furnace and/or in the direction of the molten metal to be received. The charging area can be adjacent to and/or accessible via a charging opening. Metal to be melted can be fed via the charging opening and for example deposited in the charging area. There it can heat up due to the proximity to the molten metal and the generally higher temperature inside the furnace compared to the environment. As disclosed herein, targeted heating can also be carried out for heating by means of the second heating device or another heating device. Advance heating of the solid metal accelerates its subsequent melting.

Accordingly, it can generally be provided that the melting furnace is set up to heat metal received in the charging area before it enters the melt. This can be performed in particular by supplying heated air from another area of the furnace, whereby the other area is positioned, for example, close to the second heating device, in particular if this is designed as an overhead radiator above the molten metal, or by means of a gas burner directed at the charging area or an electrically operated heating device (for example a radiant heater).

A device for circulating the furnace atmosphere can be provided to guide heated air inside the furnace, in particular in the direction of a charging area as described above. This device may, for example, comprise a blower or a fan.

According to a further development, the circulating device is positioned (for example as viewed along the molten metal flow) close to a charging opening and/or a charging area (for example closer to the charging opening and/or charging area than to the first heating device), wherein the charging opening and/or charging region may in particular be enclosed by the first or second furnace chamber of the type disclosed herein. For example, the circulating device may be no more than 2 meters or no more than 1 meter away from the charging opening and/or the charging area when viewed along the molten metal flow. This increases the flow velocity of the molten metal near the charging opening and/or the charging area. Solid metal that is supplied is therefore surrounded by molten metal at a higher speed, which enables a greater heat input into the solid metal per unit of time.

According to one variant, the melting furnace can be configured as follows: a first furnace chamber comprises the first heating device and a pump as a circulating device, each immersed in the melt. The immersion heating elements of the first heating device are arranged in such a way that the melt flows around them. Optionally, a comparatively small charging opening is provided, for example, for adding (in particular small pieces of) molten material to the melt, whereby this is arranged in such a way that the melt flows around the immersed molten material.

In a second furnace chamber through which the melt flows, the melt can be heated from above by means of a second heating device (e.g. comprising a radiant heater (in particular comprising at least one heating rod, a heating plate, a heating panel or a heating coil) or a gas burner). Furthermore, for example, a comparatively large charging opening is provided here for adding, for example, large pieces of molten material to the melt and arranged in such a way that the melt flows around the immersed molten material. The surface area of the molten metal in the second furnace chamber is preferably larger than in the first furnace chamber in order to achieve effective heat transfer and/or to immerse large pieces of molten metal. The melt circulates between the furnace chambers under the influence of the circulating device. The circulating device can also be arranged along a flow path between the furnace chambers.

It should be noted that several circulating devices can also be provided, for example each in a different furnace chamber. Several first and/or several second heating devices can also be provided, each in a different furnace chamber. For example, several furnace chambers can be provided for several groups of immersion heating elements, whereby these furnace chambers are spatially separated and/or at least one other furnace chamber without immersion heating elements is placed between them.

Furthermore, according to one aspect, an area with an at least temporary (or also partial) reduction in flow cross-section (of e.g. more than 20% compared to an area arranged upstream) can be located upstream of a charging opening of any type described herein (e.g. at a distance of less than 2 m or also less than 1 m as viewed along the flow path of the molten metal). Up to the feed opening, the flow cross-section can increase again, for example to the size upstream of the aforementioned area with reduced flow cross-section. The area with reduced flow cross-section can be at least 20 cm and/or up to 1 m long. As a result of the reduction in cross-section, molten material fed through the charging opening can flow around at a higher speed and thus experience a higher heat input per unit of time. In one variant, an area with a corresponding reduction in flow cross-section is located upstream of a plurality of and in particular all of the charging openings.

A further development provides a lateral furnace pocket for filling the melting furnace with molten metal. This can be understood as a furnace pocket arranged on a side wall of the furnace and/or laterally offset to at least one furnace chamber. This can be filled in the manner described above, in particular for an initial filling of a molten metal into the melting furnace.

As also described above, the melting furnace can be configured for detecting a filling level or, in other words a melt level detection. For this purpose, it can comprise a control unit and a sensor, which is configured to measure a level of the melt in the melting furnace (e.g. as a specific value) and/or to identify melt to a specific vertical height (in particular corresponding with a minimum permissible level or filling level) in a chamber of the melting furnace. The latter may include the detection of the presence or absence of melt at this level, in particular in the form of a purely binary detection. Furthermore, the sensor can also be configured to transmit a respective signal to the control unit, i.e. a signal indicating the measurement and/or detection result. The sensor can for example measure the distance to a melt surface. A further development of the melting furnace comprises at least one bottom weir at the bottom of the ring channel. When the furnace is emptied of melt a residual quantity up to a certain level may can remain in the furnace for various reasons. After switching off the heating devices of the furnace, this melt solidifies at the bottom. This results in a volume contraction. In a melting furnace with an ring channel, this contraction can lead to high pressures on the inner corners of the channel or on the refractory lining on these inner corners. The at least one bottom weir is preferably higher than an expected level of a solidifying residual melt in the furnace. It therefore reduces the pressure on the refractory lining. For this purpose, the at least one bottom weir is positioned in the extension of a side wall of a channel such that an inner corner of the channel is no longer present at the bottom. Any bottom weirs can be positioned in such a way that a solidified melt arranged between two bottom weirs (e.g. viewed along a flow axis) has an almost rectangular shape, in particular in a top view of the bottom. Such a rectangular solidified metal plate can then be lifted upwards out of the channel using simple tools.

Geometrically, the bottom weir defines a height difference (in other words: a step) between areas of the ring channel adjacent to the bottom weir on both sides (in particular as viewed in flow direction). The adjoining areas of the ring channel on both sides can extend at an angle of more than 45° relative to one another, in particular at an angle of approx. 90°. Consequently, the bottom weir can be positioned in a deflection, curvature or corner area of the ring channel, as explained below, or adjoin such an area in which a flow direction of the molten metal does not extend in a straight line.

As a result of the height difference the bottom weir can reduce the height of a correspondingly curved or deflected wall surface of the ring channel along which the molten metal flows. This is particularly advantageous if the molten metal solidifies, which can lead to increased stresses on such non-rectilinear wall surfaces.

The bottom weir can have a maximum height over the bottom which corresponds to at least 10% and preferably between 15% and 40% (e.g. 20%) of a maximum filling level of the molten metal (e.g. a maximum filling level in the area of the bottom weir or immediately upstream and/or downstream thereof). This enables an effective reduction of stress without excessive reduction of the flow cross-section.

According to one variant, the bottom weir has a connecting channel, which is configured for example as a depression or groove and/or which is located at a height level of the bottom of the adjacent areas of the ring channel and connects these areas to one another in a melt-conducting manner. This enables the melt to flow completely from an area upstream of the bottom weir to an area downstream of the bottom weir, for example in the direction of flow of a molten metal circulating before flowing off.

In other words, a bottom weir can have a connecting channel approximately in its center between the adjacent areas of the ring channel and thus connect these areas in a melt-conducting manner. When emptying the furnace, the melt can flow through this connecting channel. This has the advantage that the liquid residue from both areas of the ring channel, namely from the areas upstream and downstream of the bottom weir, can flow to a common point at which it is removed from the furnace. This reduces the number of points at which a device for the extraction of the residual melt needs to be provided. The connecting channel allows an inner corner to be formed in the ring channel, namely at the connecting channel. However, damage to this corner caused by contracting melt can be easily repaired with appropriate refractory materials and is generally less expensive to repair than damage to the inner corners of the ring channel side walls.

According to a further development, the melting furnace also comprises a furnace housing which delimits the ring channel (at least in some sections) and has at least one lid and a lid-lifting device, which is configured to lift the lid to make the ring channel accessible. A lid-lifting device can comprise at least one actuator for lifting the cover. The at least one immersion heating element (or any number of all of the immersion heating elements) can be attached to the lid and can be lifted together with the lid. In the raised state, the immersion heating element can be positioned at least partly or fully outside the furnace housing, for example for maintenance purposes.

The lid can be lifted essentially vertically and/or in a straight line, for example as opposed to being pivoted. This allows heat radiation to be spatially limited to an area above the furnace housing which facilitates the maintenance work.

The lid-lifting device can be arranged on a side of the melting furnace facing the inner region. Accordingly, the lid-lifting device can be maintained from the inner region.

According to a further development, the ring channel has at least one deflection area, in which a flow direction of the molten metal flow is deflected by at least 45°, preferably by 90°. The deflection area can form a corner area or curved area of the ring channel. It can in particular connect two essentially straight channel segments that extend at an angle to one another.

Side wall sections of the ring channel, which are arranged upstream and downstream of the deflection area in the direction of flow, can merge into one another in a rounded manner or be provided with a chamfer. In particular, these side wall sections can be surrounded by an inner side of the ring channel closer to the inner area of the melting furnace, i.e. they can form inner side walls as opposed to outer side walls. The deflection area can therefore also be on the inside and/or define an inner deflection or an inner corner area. Alternatively or in addition, side wall sections, which are enclosed by an outer side of the ring channel remote from the inner region of the melting furnace, can merge into one another in a round manner or be provided with a chamfer. In other words, the ring channel and in particular its inner walls can have rounded or chamfered corner areas, for example in an aforementioned deflection area. The provision of a chamfer can involve connecting two wall sections extending at a large angle, e.g. 90° to one another, by means of an intermediate section, in particular a flat section, which extends at a smaller angle to each of these wall sections. This means that the deflection between the wall sections is less sharp-edged.

The rounded or chamfered transitions reduce stress peaks in the event of the solidification of the molten metal. These stress peaks could otherwise damage a refractory lining of the melting furnace.

The invention also relates to a melting furnace for melting metal, also including:
a molten metal received in the melting furnace;
a first heating device with at least one electrically heatable immersion heating element;
a circulating device, which is configured for producing a flow of molten metal flowing around the immersion heating element.

All of the features, further developments and variants of a melting furnace and of its features disclosed herein can also be provided in this melting furnace with the molten metal contained therein.

Furthermore, the invention also relates to a method for melting metal by means of a melting furnace according to any aspect disclosed herein, wherein the method comprises:
producing the molten metal flow by means of the circulating device, such that the molten metal flow flows around the immersion heating element.

The method can also include all further steps and measures for providing any operating conditions, interactions and functions of a melting furnace disclosed herein. For example, the method can also comprise the step of supplying metal to be melted through a charging opening, wherein the charging opening can be formed and arranged according to any variant described here.

The invention also relates to a method for producing a melting furnace having a ring channel (for example configured according to any aspect disclosed here), in which a molten metal can be circulated, the method comprising: connecting individual modules to form at least a portion of the melting furnace, each module comprising a channel segment of the ring channel and, in particular, an inflow opening and at least one outflow opening. The modules and the melting furnace may be formed according to any aspect disclosed herein. The modules can be selected and/or combined from a plurality of modules that can in principle be installed.

Exemplary embodiments are described in more detail with reference to the accompanying figures.

In the latter:

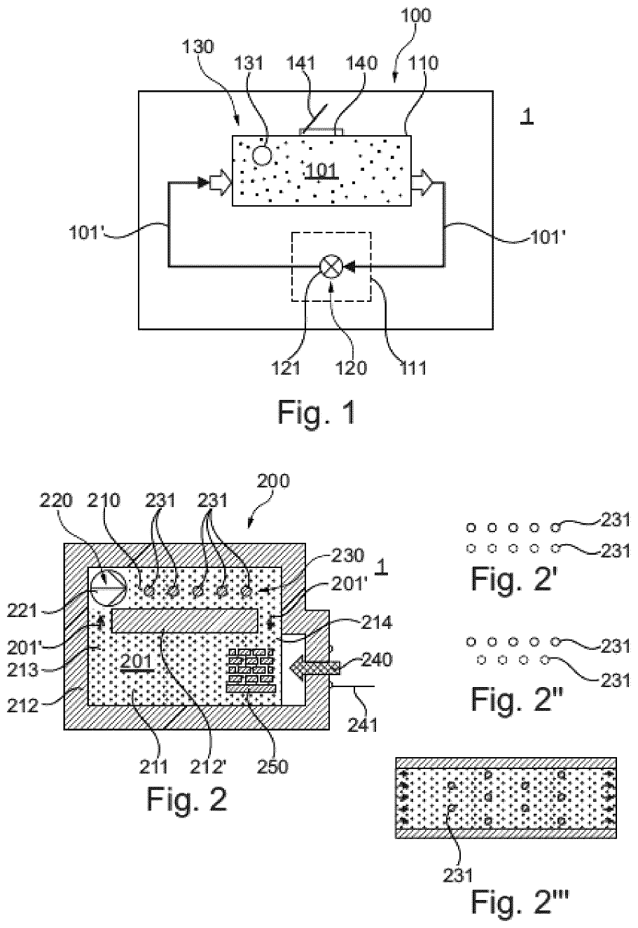

FIG. 1 shows a schematic representation of a melting furnace for melting metal;

FIG. 2 shows a schematic representation of a melting furnace for melting metal according to a further exemplary embodiment;

FIG. 2′ shows a schematic representation of a possible alternative arrangement of the immersion heating elements of FIG. 2 in the melting furnace of FIG. 2;

FIG. 2″ shows a schematic representation of a possible further alternative arrangement of the immersion heating elements of FIG. 2 in the melting furnace of FIG. 2;

FIG. 2′″ shows a schematic representation of a possible further alternative arrangement of the immersion heating elements of FIG. 2 in the melting furnace of FIG. 2;

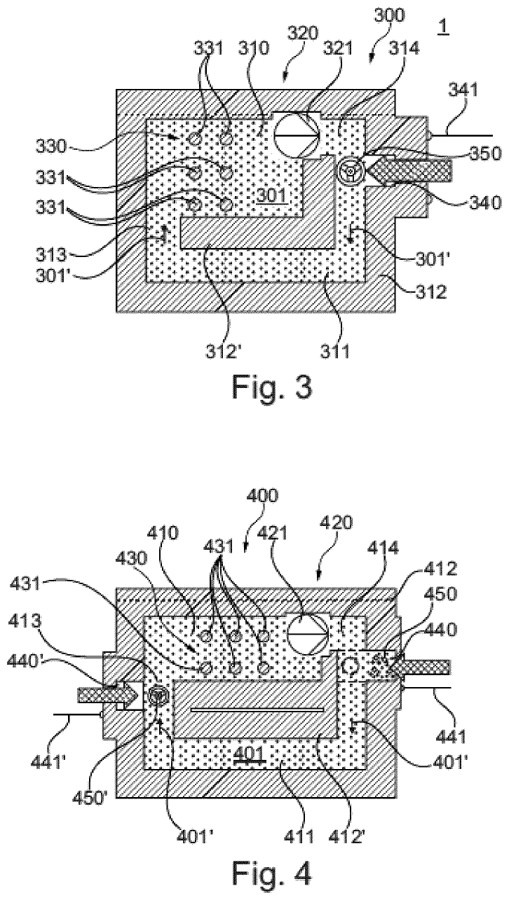

FIG. 3 shows a schematic representation of a possible embodiment of a melting furnaces for melting metal according to a further exemplary embodiment;

FIG. 4 shows a schematic representation of a possible embodiment of a melting furnace for melting metal according to a further exemplary embodiment;

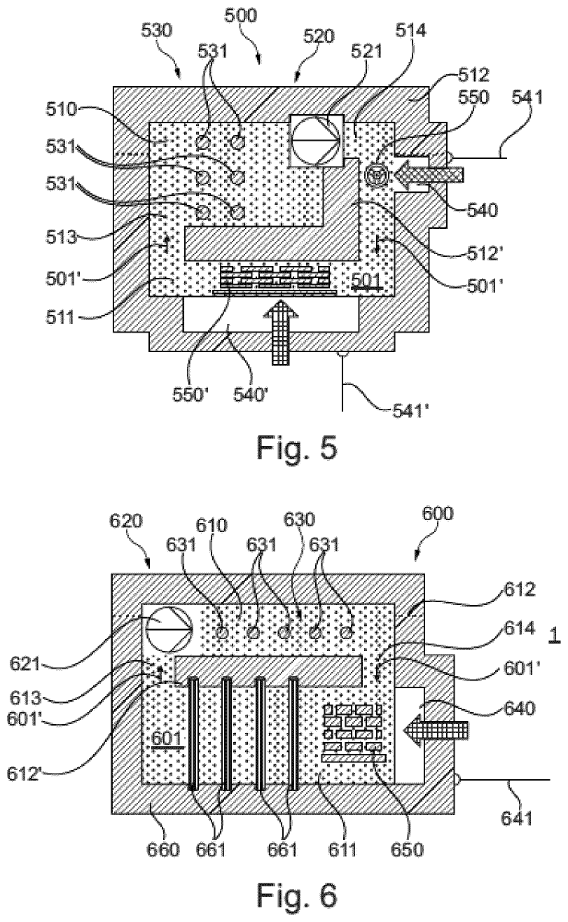

FIG. 5 shows a schematic representation of a possible embodiment of a melting furnace for melting metal according to a further exemplary embodiment;

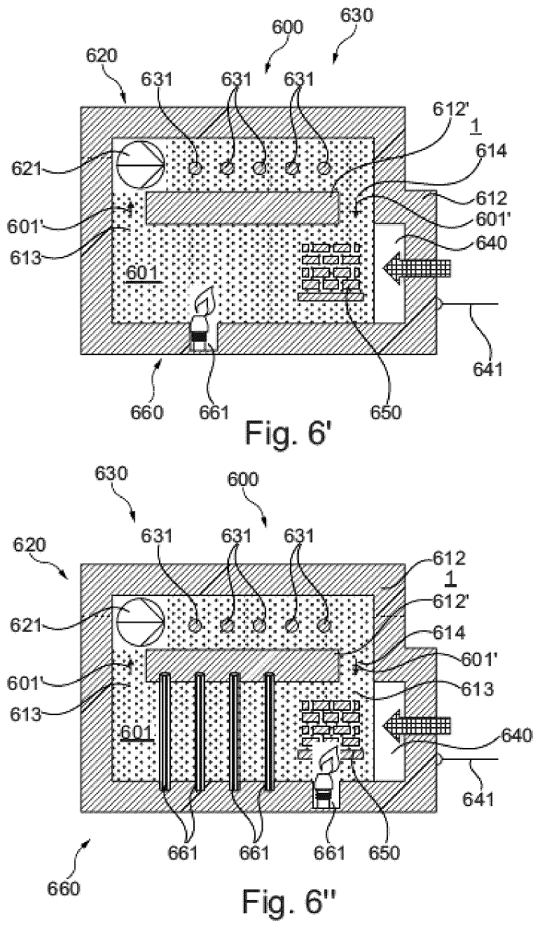

FIG. 6 shows a schematic representation of a possible embodiment of a melting furnace for melting metal according to a further exemplary embodiment;

FIG. 6′ shows the exemplary embodiment of FIG. 6, wherein instead of heating rods, gas burners are provided as second heating elements;

FIG. 6″ shows the exemplary embodiment of FIG. 6, wherein both heating rods and gas burners are provided as second heating elements;

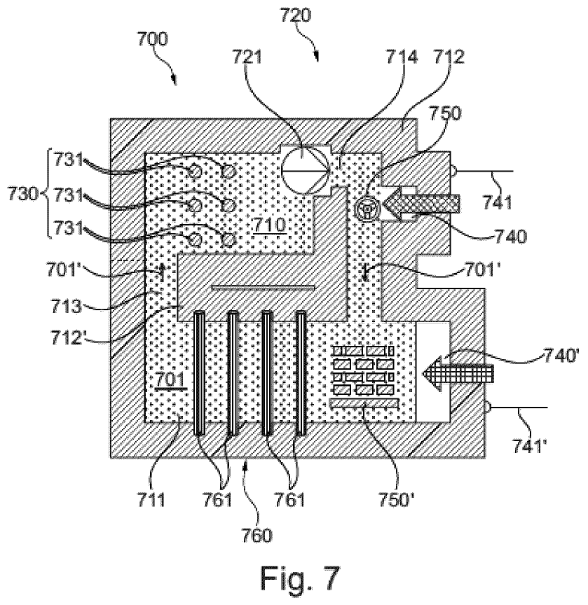

FIG. 7 shows a schematic representation of a possible embodiment of a melting furnace for melting metal according to a further exemplary embodiment;

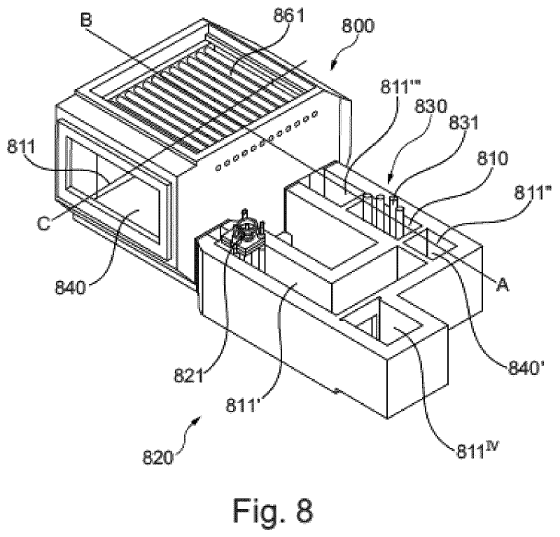

FIG. 8 shows a schematic, perspective view of a melting furnace;

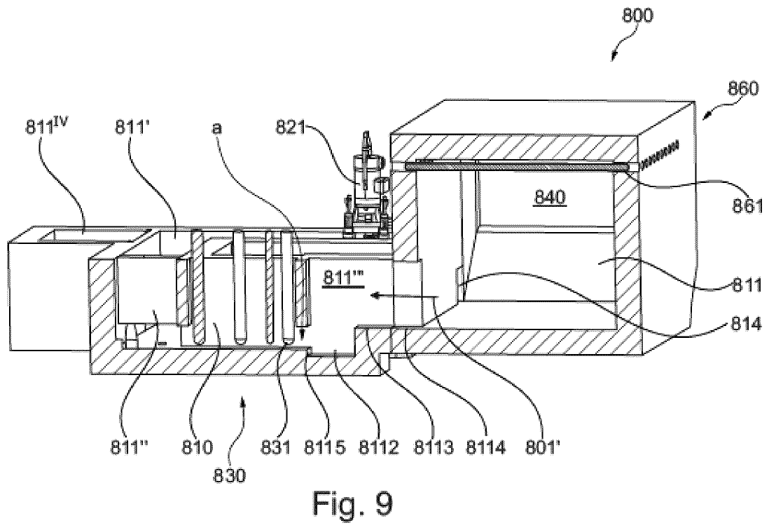

FIG. 9 shows the melting furnace of FIG. 8 in a section along a plane defined by the lines A and B drawn in FIG. 8;

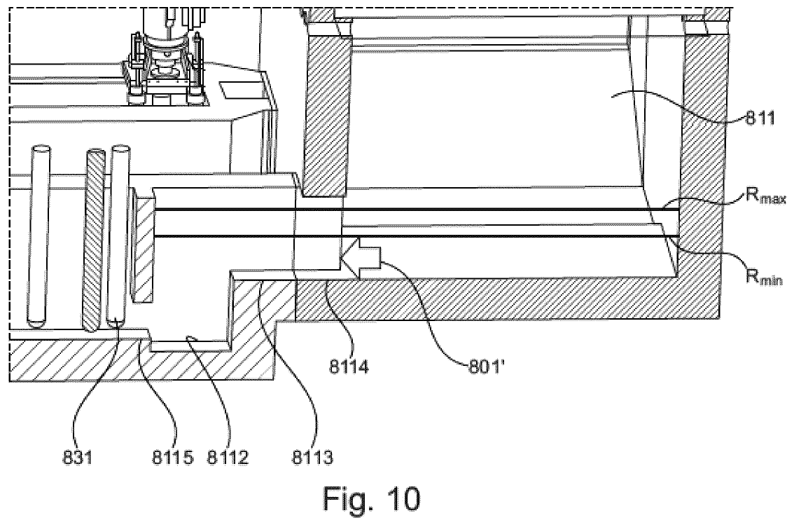

FIG. 10 shows a section of FIGS. 8 and 9;

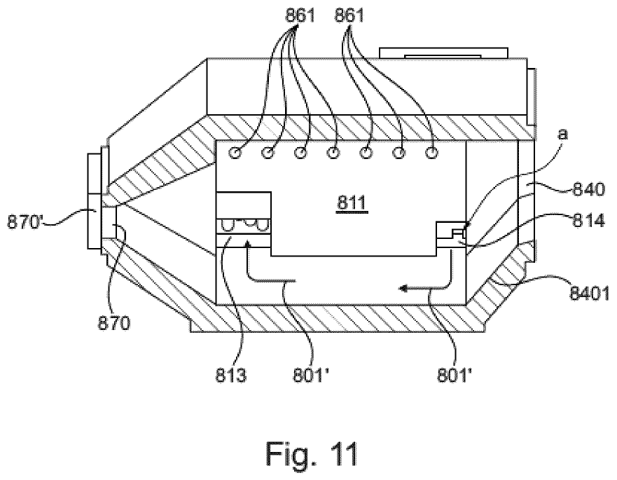

FIG. 11 shows a cross-section of the second furnace chamber of the melting furnace of FIGS. 8 to 10;

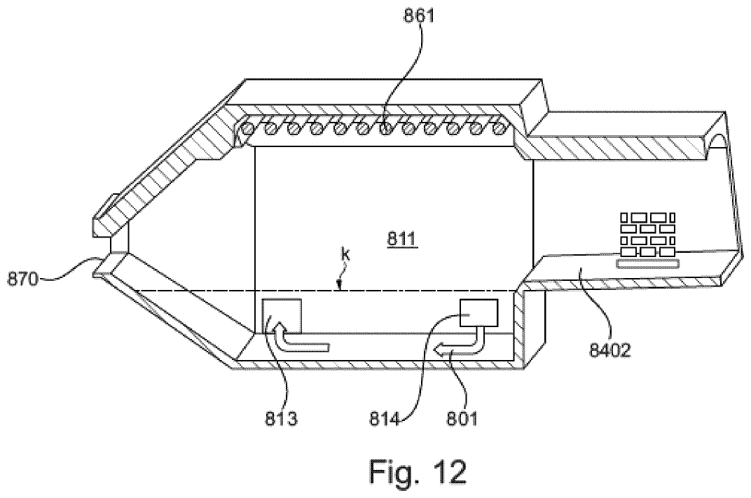

FIG. 12 shows a cross-section of the second furnace chamber of the melting furnace of FIGS. 8 to 11 in which a charging ramp is provided;

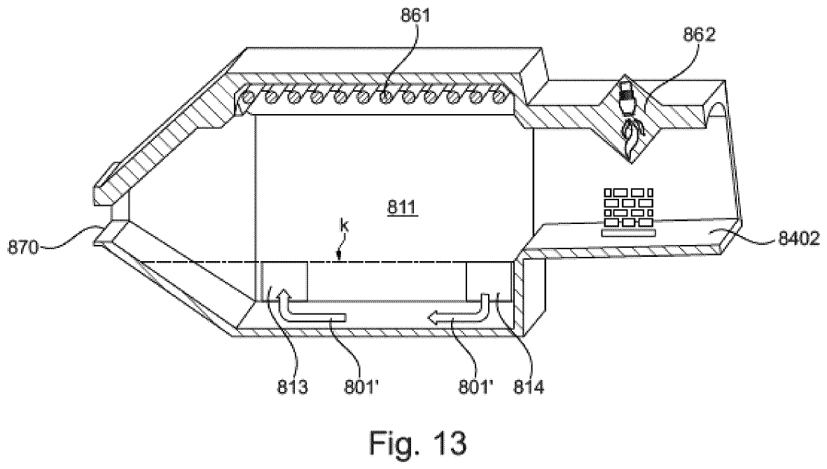

FIG. 13 shows a cross-section of the second furnace chamber of the melting furnace of FIGS. 8 to 12 in which a charging ramp with gas burners is provided;

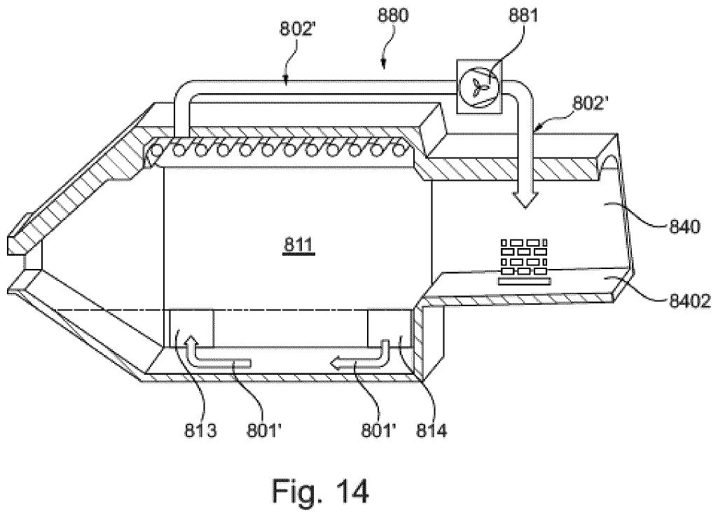

FIG. 14 shows a cross-section of the second furnace chamber of the melting furnace of FIGS. 8 to 13, wherein a charging ramp and a gas-circulating device are provided;

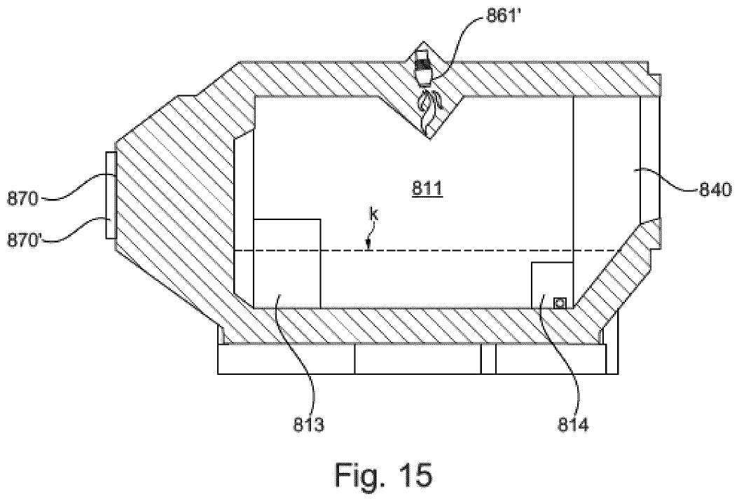

FIG. 15 shows a cross-section of the second furnace chamber of the melting furnace of FIGS. 8 to 14, wherein gas burners are provided instead of electrical heating elements;

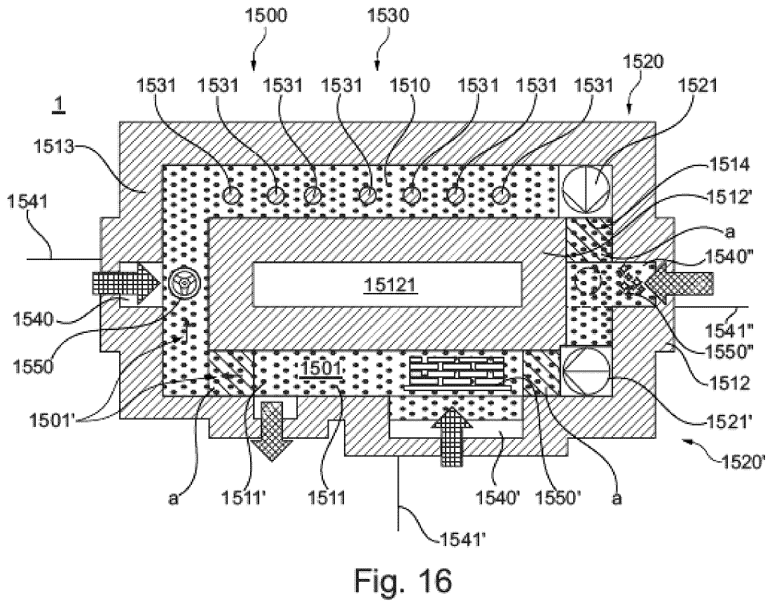

FIG. 16 shows a schematic representation of a possible embodiment of a melting furnace for melting metal according to a further exemplary embodiment;

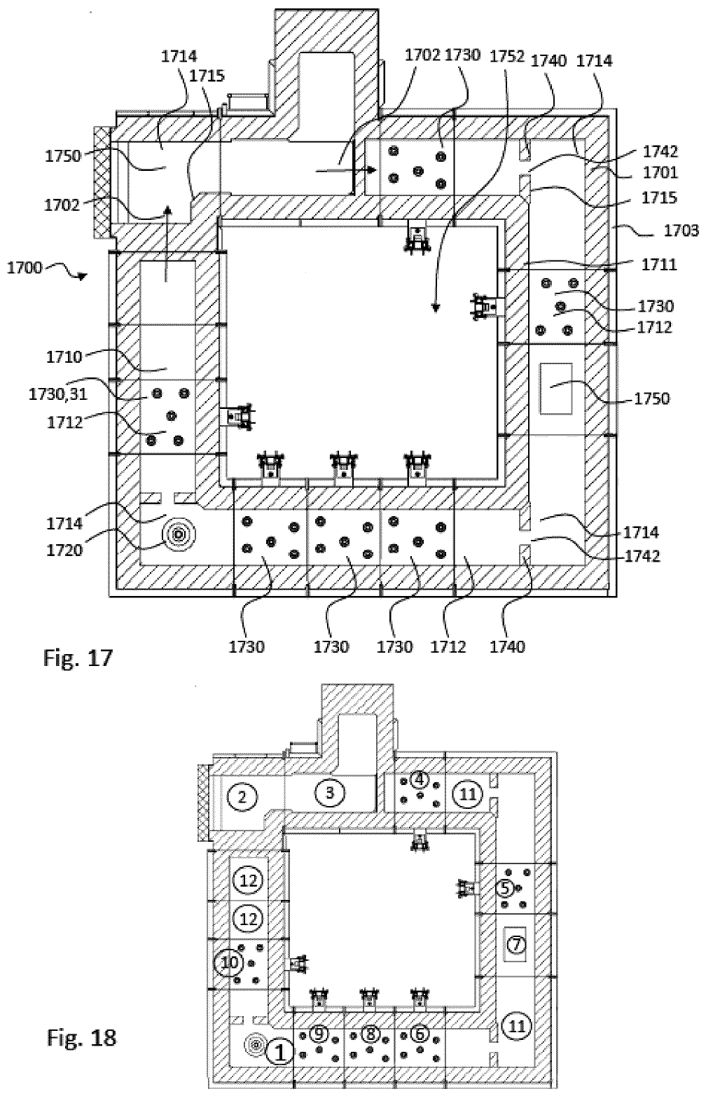

FIG. 17 shows a cross-sectional view of a melting furnace for melting metal according to a further exemplary embodiment;

FIG. 18 shows a representation of a subdivision of the melting furnace of FIG. 17 into individual modules;

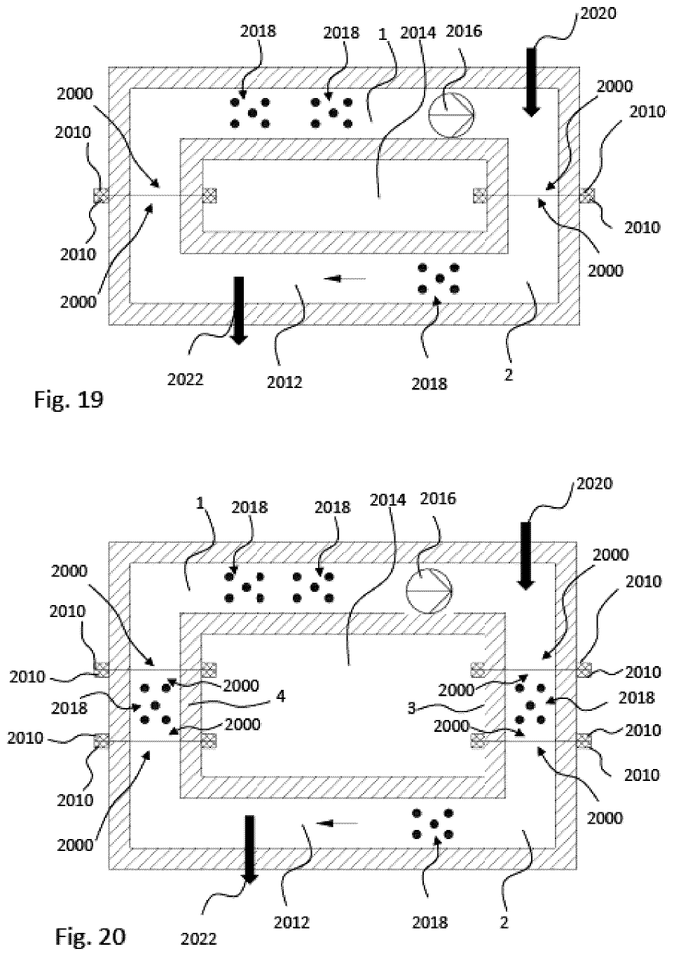

FIG. 19 shows a representation of a melting furnace according to a further exemplary embodiment with an annular melt channel and subdivision into two modules;

FIG. 20 shows a representation of a melting furnace according to a further exemplary embodiment with an annular melt channel and subdivision into four modules;

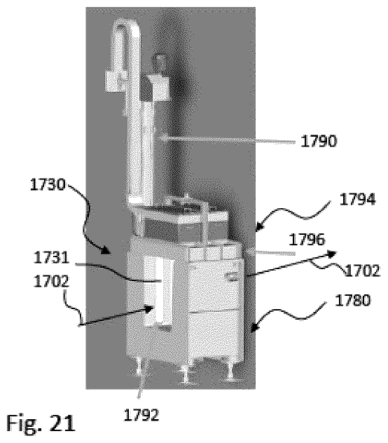

FIG. 21 shows a view of a single module of the melting furnace from FIGS. 17 & 18, wherein the single module comprises a lid-lifting device.

FIG. 1 shows a schematic representation of a melting furnace 100 for melting metal. The melting furnace 100 is particularly suitable for melting metals with a melting point of below 900° C.

The melting furnace comprises a first furnace chamber 110. The melting furnace 100 has a first charging opening 140. The charging opening 140 is configured for supplying metal to be melted. The charging opening 140 is arranged on the furnace chamber 110 such that the metal to be melted, referred to in the following as charging material, can be introduced from an environment 1 surrounding the melting furnace 100 through the charging opening 140 into the first furnace chamber, when the charging opening is open. The charging opening 140 can be closed by a charging opening door 141. A furnace interior comprising the furnace chamber 110 can be closed off, for example by the charging opening door 140, from an environment surrounding the melting furnace. The furnace interior can comprise further furnace chambers and/or melt channels.

In particular, areas of the melting furnace 100, which are configured to come into contact with molten metal, are lined with refractory material. For example, the furnace chamber 110 is lined with refractory material. The refractory-lined areas, for example comprising the furnace chamber 110, are configured to withstand temperatures of up to 1600° C. and/or up to 1100° C. and/or up to 600° C. For this purpose, a molten metal located in the melting furnace, in particular the furnace chamber 110, can be heated to temperatures of at least 300° C. (e.g. lead) and/or at least 420° C. (e.g. zinc) and/or at least 600° C. (e.g. aluminum alloy) and/or a maximum of 900° C. (e.g. special Al alloy).

The melting furnace 100 can be heated electrically. The melting furnace 100 comprises a first heating device 130 with an electrically heatable immersion heating element 131, which is arranged in the furnace chamber 110. The immersion heating element 131 can be powered electrically to generate heat. The immersion heating element 131 has a refractory lining and can be immersed in molten metal in order to heat it. The furnace chamber 110 is filled at least partly with a molten metal 101, for example molten aluminum. Molten aluminum comprises aluminum. Molten aluminum can be an aluminum alloy, for example. The furnace chamber 110 contains about 70% of the molten metal 101, which is arranged in the melting furnace 100. The molten metal 101 flows around the immersion heating element 131. The molten metal 101 has a temperature of about 750° C. The melting furnace 100 comprises a circulating device 120, which is configured to create a molten metal flow, at least partly represented by the arrows 101′, within the melting furnace. The circulating device 120 comprises a pump 121 for conveying the molten metal 101. The circulating device 120 is arranged and configured such that the molten metal flow 101′ circulates between the immersion heating element 131 and the pump 121. The pump 121 can be arranged in the furnace chamber 110 or outside the furnace chamber 110, wherein the representation outside the furnace chamber 110 in FIG. 1 is not restrictive. The pump 121 can be arranged in a second furnace chamber 111. Alternatively, the pump 121 can be connected to the furnace chamber 110 in a fluid-conducting manner via melt channels. The melt channels have a refractory lining. The melt channels can be configured at least in some sections as closed pipes and/or at least in some section as open channel. The melt channels can be heated.

The pump 121 can be arranged next to the immersion heating element 131 such that an intake connection of the pump 121 is arranged facing away from the immersion heating element 131 and a pressure connection of the pump 121 is arranged facing away from the immersion heating element 131. If the pump 121 is connected to the furnace chamber 110 in a fluid-conducting manner via melt channels, a first melt channel connected fluidically to the furnace chamber is connected fluidically to the intake connection of the pump 121 and a second melt channel connected fluidically to the furnace chamber 110 is connected fluidically to the pressure connection of the pump 121. The second melt channel can open into the furnace chamber 110 next to the immersion heating element 131 and the first melt channel can open into the furnace chamber 110 at a distance from the immersion heating element 131, such that the pump 121 can generate a melt flow which at least partially bypasses the immersion heating element 131.

In particular, the circulating device 120 and the first heating device 130 are arranged such that the flow flows around the immersion heating body in the form of the immersion heating element 131, wherein the convective heat transfer from the immersion heating element 131 to the molten metal in a flow region around the immersion heating body is significantly higher (e.g. at least 20%, at least 50% or at least 80% higher), than the heat transfer from the immersion heating element 131 to non-flowing molten metal of the same temperature and composition. The flow region is in particular an area in which the molten metal 101 has a speed of at least 4 cm/s, when the pump 121 is switched on and circulates the molten metal 101.

When the pump 121 is switched on, the molten metal 101 flows from the pressure connection of the pump 121 to the intake connection of the pump 121. The molten metal 101 is thus suctioned in by the pump 121 and thereby circulated. The molten metal 101 flows through the furnace chamber 110 with the immersion heating element 131 and is heated thereby. When melt has been introduced into the furnace chamber 110 via the charging opening 140, melt is located in the furnace chamber 110. When the pump 121 is switched on the molten metal flows around the charging material in the furnace chamber 110 and heats it so that it melts.

It can thus be seen that the molten metal circulates inside the melting furnace 100. The flow path runs through a type of ring channel, which in particular comprises all of the furnace chambers and melting channels described.

Alternatively or in addition, further furnace chambers can be provided, which can in particular each have a charging opening. The further furnace chambers can be configured and arranged such that the molten metal 101 is circulated by the pump 121 such that it flows through the further furnace chambers. Connecting channels and or connecting openings between the furnace chambers can be configured such that charging material from one furnace chamber is not moved into a downstream furnace chamber (in flow direction) or is only moved when a maximum variable is reached. The further charging openings of the further furnace chambers can have smaller dimensions than the charging opening 140. The further furnace chambers can also be suitable for receiving and melting charging material, for example in the form of metal shavings. The furnace chamber 110 and the charging opening 140 can in particular be configured to receive larger charging material. The larger charging material can comprise metal objects for example, which have a maximum length and/or width of at least 30 cm and/or at least 40 cm and/or at least 50 cm respectively. The larger charging material can for example comprise metal objects which each have a maximum length and/or width of at most 300 cm and/or at most 200 cm and/or at most 100 cm. The charging opening then has a length of 300 cm and a height of 200 cm or 200 cm×150 cm or 100 cm×100 cm. For example, charging material in small pieces can contain metal objects which can be introduced into the furnace through a charging opening with a maximum size of approx. 8 cm×5 cm or approx. 60 cm×60 cm.

The exemplary embodiment of FIG. 1 can additionally comprise a second heating device (not shown in FIG. 1, but explained in the following and with reference to FIG. 6 for example). In particular, the second heating device can be arranged in the region of the second furnace chamber 111. The second heating device can in particular be an electrical heating device. In particular, the second heating device can be arranged in an area which does not come into contact with melt. In particular, the second heating device can be arranged above the melt. The second heating device can comprise second heating elements in the form of heating rods, heating plates, heating panels or heating coils. In addition or alternatively, the second heating device can comprise heating elements in the form of gas burners. The heating elements can be arranged under a ceiling of a furnace chamber, in particular one or both of the furnace chambers 110, 111. In particular, the heating rods are electrically operated. When switched on, the heating elements can radiate heat so that the melt is heated underneath the second heating elements.

FIG. 2 shows a schematic representation of a melting furnace 200 for melting metal. FIG. 2 shows the melting furnace 200 in a horizontal cross-section of the melting furnace 200 in a plan view.

The melting furnace 200 is particularly suitable for melting metals with a melting point of below 900° C.

The melting furnace comprises a first furnace chamber 210 and a second furnace chamber 211. The first furnace chamber 210 and the second furnace chamber 211 are formed by furnace walls 212. A dividing wall 212′ separates the first furnace chamber 210 from the second furnace chamber 211. The first furnace chamber 210 and the second furnace chamber 211 are connected to one another fluidically via a first connecting opening 213 and a second connecting opening 214.

The melting furnace 200 has a first charging opening 240. The charging opening 240 is configured for feeding metal to be melted. The charging opening 240 is arranged on the furnace chamber 211 such that metal to be melted, referred to in the following as a charging material, can be introduced from an environment 1 surrounding the melting furnace 200 through the charging opening 240 into the second furnace chamber 211, when the charging opening 240 is opened. The charging opening 240 has a width of 120 cm and a height of 120 cm. The charging opening 240 can be closed by a charging opening door 241. A furnace interior, comprising the furnace chamber 210 and the second furnace chamber 211, can be closed off from the environment 1 surrounding the melting furnace by the charging opening door 240.

In particular, areas of the melting furnace 200, which are configured to come into contact with molten metal, are lined with refractory material. For example, the furnace chamber 210 and the furnace chamber 211 are at least partially lined with refractory material. The areas with a refractory lining are configured to withstand temperatures of at least −50° C. and/or at least −20° C. and/or at least 0° C. The refractory-lined areas are configured to withstand temperatures of up to 1500° C. and/or up to 1100° C. and/or up to 600° C. For this purpose, a molten metal located in the melting furnace, in particular in the furnace chamber 110, can be heated to temperatures of at least 300° C. and/or at least 420° C. and/or at least 600° C. and/or a maximum of 900° C.

The melting furnace 200 can be heated electrically. The melting furnace 200 comprises a first heating device 230 with electrically heatable immersion heating elements 231, which are arranged in the furnace chamber 210. Preferably, five immersion heating elements 231 are arranged in the furnace chamber 210. The immersion heating elements 231 can be operated electrically to produce heat. The immersion heating elements 231 have a refractory surface and can be immersed in molten metal to heat it.

The furnace chambers 210 and 211 are filled at least partially with the molten metal 201, for example a molten aluminum. The molten aluminum comprises aluminum. The molten aluminum can for example be an aluminum alloy. The furnace chamber 211 contains about 60% of the molten metal 201, which is arranged in the melting furnace 200. The furnace chamber 210 contains about 40% of the molten metal 201, which is arranged in the melting furnace 200. The molten metal 201 has a temperature of about 750° C.

The melting furnace 200 comprises a circulating device 220, which is configured to produce a molten metal flow, at least partly represented by arrows 2011, inside the melting furnace 200. The circulating device 220 comprises a pump 221 for conveying the molten metal 201.

The circulating device 220 is arranged and configured such that the molten metal flow 201′ circulates between the immersion heating elements 231 and the pump 221. The pump 221 is arranged in the first furnace chamber 210. An intake connection of the pump 221 is connected to the first connecting opening in a sealing manner such that molten metal 201 flowing through the first connecting opening flows into the pump 221. A pressure connection of the pump 221 is arranged facing the immersion heating elements 231. The second connecting opening is arranged downstream of the immersion heating elements 231, so that the molten metal 201, which is conveyed by the pump 221, flows through the first furnace chamber 210, flows around the immersion heating elements 231 and then flows through the second connecting opening into the second furnace chamber 211. The molten metal 201 is heated as it flows around the immersion heating elements 231. It can thus be seen that the molten metal circulates inside the melting furnace 100. The flow path runs through a type of ring channel, which comprises in particular all of the furnace chambers described.

For example, the immersion heating elements 231 can be arranged in flow direction in a row. Alternatively, one or more further rows of immersion heating elements 231 can be provided. The immersion heating elements 231 of a first row can be arranged exactly next to the immersion heating elements 231 of a second row. This is shown schematically in FIG. 21, wherein the immersion heating elements 231 of the first row are shown filled in and the immersion heating elements 231 of the second row are shown by dashed lines. The immersion heating elements 231 of a first row can be arranged offset to the immersion heating elements 231 of a second row. This is shown schematically in FIG. 2″, wherein the immersion heating elements 231 of the first row are shown filled in and the immersion heating elements 231 of the second row are shown by dashed lines.

The immersion heating elements can be arranged to be offset in flow direction. In particular, this can be performed such that—as viewed from the inflow opening of the chamber—they block the flow cross-section of the molten metal flow by more than 20%, as shown schematically in FIG. 2′″.

When melt 250 has been introduced into the furnace chamber 211 through the charging opening 240, melt 250 is located in the furnace chamber 211. When the pump 221 is switched on, the molten metal 201 flows around the melt 250 located in the furnace chamber 211 and heats it so that it melts. The molten metal 201 flows from the connecting opening 214 through the second furnace chamber 211, flows around the melt 250 and flows to the intake connection of the pump 221 connected to the connecting opening 213.

Alternatively or in addition to the pump 221, the circulating device 220 can comprise a stirrer for circulating the molten metal. The stirrer may be arranged for example at least partially outside the furnace chambers and can be electromagnetic. At least a portion of the stirrer can be arranged for example below the furnace chambers. By applying an alternating electromagnetic field, the molten metal 201 can be set into rotation. Any stirrer mentioned in the context of the exemplary embodiments can be configured according to any one of the above variants.

The exemplary embodiment of FIG. 2 can additionally comprise a second heating device (not shown). In particular, the second heating device can be arranged in the region of the second furnace chamber 211. The second heating device can in particular be an electrical heating device. In particular, the second heating device can be arranged in an area which does not come into contact with melt. In particular, the second heating device can be arranged above the melt. The second heating device can comprise second heating elements in the form of heating rods, heating plates, heating panels or heating coils. In addition or alternatively, the second heating device can comprise heating elements in the form of gas burners. The heating elements can be arranged under a ceiling of a furnace chamber, in particular one or both of the furnace chambers 210, 211. In particular, the heating rods are electrically operated. When switched on, the heating elements can radiate heat so that the melt is heated underneath the second heating elements.

FIG. 3 shows a schematic representation of a melting furnace 300 for melting metal. FIG. 3 shows the melting furnace 300 in a horizontal cross-section of the melting furnace 300 in a plan view.

The melting furnace 300 is particularly suitable for melting metals with a melting point of below 900° C. The melting furnace 300 is in particular suitable for melting lumpy charging material (melt 350), for example the size of a car wheel rim.

The melting furnace comprises a first furnace chamber 310 and a second furnace chamber 311. The first furnace chamber 310 and the second furnace chamber 311 are formed by furnace walls 312. A dividing wall 312′ separates the first furnace chamber 310 from the second furnace chamber 311. The first furnace chamber 310 and the second furnace chamber 311 are connected to one another fluidically via a first connecting opening 313 and a second connecting opening 314.

The melting furnace 300 has a first charging opening 340. The charging opening 340 is configured for supplying metal to be melted, in particular melt 350, in the present case a car wheel rim for example. The charging opening 240 is arranged on the furnace chamber 311 such that the melt 350 can be introduced from an environment 1 surrounding the melting furnace 300 through the charging opening 340 into the second furnace chamber 311, when the charging opening 340 is open. The charging opening 340 has a width of 60 cm and a height of 60 cm. The charging opening 340 can be closed by a charging opening door 341. A furnace interior, comprising the furnace chamber 310 and the second furnace chamber 311, can be closed off from the environment 1 surrounding the melting furnace by the charging opening door 340.

In particular, areas of the melting furnace 300, which are configured to come into contact with molten metal, are lined with refractory material. For example, the furnace chamber 310 and the furnace chamber 311 are at least partially lined with refractory material. The refractory-lined areas are configured to withstand temperatures of up to 1500° C. and/or up to 1100° C. and/or up to 600° C. For this purpose, a molten metal located in the melting furnace, in particular in the furnace chamber 110, can be heated to temperatures of at least 300° C. and/or at least 420° C. and/or at least 600° C. and/or a maximum of 900° C.

The melting furnace 300 can be heated electrically. The melting furnace 300 comprises a first heating device 330 with electrically heatable immersion heating elements 331, which are arranged in the furnace chamber 310. Preferably, six immersion heating elements 331 are arranged in the furnace chamber 310. The immersion heating elements 331 can be operated electrically to produce heat. The immersion heating elements 331 have a refractory surface and can be immersed in molten metal to heat it.

The furnace chambers 310 and 311 are filled at least partially with the molten metal 301, for example a molten aluminum. The molten aluminum comprises aluminum. The molten aluminum can for example be an aluminum alloy. The furnace chamber 311 contains about 20% of the molten metal 301, which is arranged in the melting furnace 300. The furnace chamber 310 contains about 80% of the molten metal 201, which is arranged in the melting furnace 300. The molten metal 301 has a temperature of about 750° C.

The melting furnace 300 comprises a circulating device 320, which is configured to produce a molten metal flow, at least partly represented by arrows 301′, inside the melting furnace 300. The circulating device 320 comprises a pump 321 for conveying the molten metal 301.

The circulating device 320 is arranged and configured such that the molten metal flow 301′ circulates between the immersion heating elements 331 and the pump 321. The pump 321 is arranged in the first furnace chamber 310. A pressure connection of the pump 321 is connected in a sealing manner to the second connecting opening 314, such that molten metal 301 that flows through the second connecting opening flows firstly through the pump 321. An intake connection of the pump 321 is arranged facing the immersion heating elements 331. The second connecting opening 313 is arranged upstream of the immersion heating elements 231, so that the molten metal 301, which is conveyed by the pump 321, flows through the first furnace chamber 310, flows around the immersion heating elements 331, flows into the pump 321 and then flows through the second connecting opening 314 into the second furnace chamber 311. It can thus be seen that the molten metal circulates inside the melting furnace 100. The flow path runs through a type of ring channel, which comprises in particular all of the furnace chambers described.

The molten metal 301 is heated as it flows around the immersion heating elements 331. In particular, the immersion heating elements 331 can be arranged in flow direction in three rows. Alternatively, one or more further rows or only one or two rows of immersion heating elements 331 can be provided. In this case, the immersion heating elements 331 of a first row can be arranged offset from immersion heating elements 331 of a second row. The immersion heating elements 331 of a first row can alternatively be arranged behind one another or in alignment with the immersion heating elements 331 of a second row. This is shown schematically in FIG. 3. Several immersion heating elements 331 can also be arranged downstream in alignment with one another and some further immersion heating elements 331 can be arranged downstream offset to one another.

When melt 350 has been introduced into the furnace chamber 311 through the charging opening 340, melt 350 is located in the furnace chamber 311. When the pump 321 is switched on, the molten metal 301 flows around the melt 350 located in the furnace chamber 311 and heats it so that it melts. The molten metal 301 flows from the pressure connection of the pump 331 from the connecting opening 314 through the second furnace chamber 311, flows around the melt 350 and flows through the connecting opening 313, flows around the immersion heating elements 331 in the first furnace chamber 310 and flows to the intake connection of the pump 321.

Alternatively or in addition to a pump 321, the circulating device 320 can comprise a stirrer for circulating the molten metal 301. The stirrer can be arranged for example outside the furnace chambers and can be electromagnetic. For example, the stirrer can be arranged underneath the furnace chambers. By applying an alternating electromagnetic field, the molten metal 301 can be set into rotation.

The exemplary embodiment of FIG. 3 can additionally comprise a second heating device (not shown). In particular, the second heating device can be arranged in the region of the second furnace chamber 311. The second heating device can in particular be an electrical heating device. In particular, the second heating device can be arranged in an area which does not come into contact with melt. In particular, the second heating device can be arranged above the melt. The second heating device can comprise second heating elements in the form of heating rods, heating plates, heating panels or heating coils. In addition or alternatively, the second heating device can comprise heating elements in the form of gas burners. The heating elements can be arranged under a ceiling of a furnace chamber, in particular one or both of the furnace chambers 310, 311. In particular, the heating rods are electrically operated. When switched on, the heating elements can radiate heat so that the melt is heated underneath the second heating elements.

FIG. 4 shows a schematic representation of a melting furnace 400 for melting metal. FIG. 4 shows the melting furnace 400 in a horizontal cross-section of the melting furnace 400 in a plan view.

The melting furnace 400 is particularly suitable for melting metals with a melting point of below 900° C. The melting furnace 400 is particularly suitable for melting both melt 450, for example in the form of metal shavings, and lumpy charging material 450′, for example in the size of a car wheel rim.

The melting furnace comprises a first furnace chamber 410 and a second furnace chamber 411. The first furnace chamber 410 and the second furnace chamber 411 are formed by furnace walls 412. A dividing wall 412′ separates the first furnace chamber 410 from the second furnace chamber 411. The first furnace chamber 410 and the second furnace chamber 411 are connected to one another fluidically via a first connecting opening 413 and a second connecting opening 414.

The melting furnace 400 has a first charging opening 440. The charging opening 440 is configured to supply metal to be melted, in particular melt 450, in the present case metal shavings for example. The charging opening 440 is arranged on the furnace chamber 411 such that the melt 450 can be introduced from an environment 1 surrounding the melting furnace 400 through the charging opening 440 into the second furnace chamber 411, when the charging opening 440 is open. The charging opening 440 has a width of 40 cm and a height of 40 cm. The charging opening 440 can be closed by a charging opening door 441. The first charging opening 440 is arranged at a first end of the second furnace chamber 411 in the region of the second connecting opening 414.

The melting furnace 400 has a second charging opening 440′. The charging opening 440′ is configured for feeding metal to be melted, in particular melt 450′, in the present case a car wheel rim for example. The charging opening 440′ is arranged on the furnace chamber 411 such that the melt 450′ can be introduced from an environment 1 surrounding the melting furnace 400 through the charging opening 440′ into the second furnace chamber 411 when the charging opening 440′ is open. The charging opening 440′ has a width of 60 cm and a height of 60 cm. The charging opening 440′ can be closed by a charging opening door 441′. The second charging opening 440′ is arranged at a second end of the second furnace chamber 411 in the region of the first connecting opening 413. A furnace inner region, comprising the furnace chamber 410 and the second furnace chamber 411, can be closed off from the environment 1 surrounding the melting furnace 400 by the charging opening doors 440 and 440′.

In particular, areas of the melting furnace 400, which are configured to come into contact with molten metal, are lined with refractory material. For example, the furnace chamber 410 and the furnace chamber 411 are at least partially lined with refractory material. The refractory-lined areas are configured to withstand temperatures of up to 1500° C. and/or up to 1100° C. and/or up to 600° C. For this purpose, a molten metal located in the melting furnace, in particular in the furnace chamber 110, can be heated to temperatures of at least 300° C. and/or at least 420° C. and/or at least 600° C. and/or a maximum of 900° C.

The melting furnace 400 can be heated electrically. The melting furnace 400 comprises a first heating device 430 with electrically heatable immersion heating elements 431, which are arranged in the furnace chamber 410. Preferably, six immersion heating elements 431 are arranged in the furnace chamber 410. The immersion heating elements 431 can be operated electrically to produce heat. The immersion heating elements 431 have a refractory surface and can be immersed in molten metal to heat it.

The furnace chambers 410 and 411 are filled at least partially with the molten metal 401, for example a molten aluminum. The molten aluminum comprises aluminum. The molten aluminum can for example be an aluminum alloy. The furnace chamber 411 contains about 20% of the molten metal 401, which is arranged in the melting furnace 400. The furnace chamber 410 contains about 80% of the molten metal 201, which is arranged in the melting furnace 400. The molten metal 401 has a temperature of about 750° C.

The melting furnace 400 comprises a circulating device 420, which is configured to produce a molten metal flow, at least partly represented by arrows 401′, inside the melting furnace 400. The circulating device 420 comprises a pump 421 for conveying the molten metal 401.

The circulating device 420 is arranged and configured such that the molten metal flow 401′ circulates between the immersion heating elements 431 and the pump 421. The pump 431 is arranged in the first furnace chamber 410. A pressure connection of the pump 421 is connected in a sealing manner to the second connecting opening 414, such that molten metal 401 that flows through the second connecting opening flows firstly through the pump 421. An intake connection of the pump 421 is arranged facing the immersion heating elements 431. The second connecting opening 413 is arranged upstream of the immersion heating elements 231, so that the molten metal 401, which is conveyed by the pump 421, flows through the first furnace chamber 410, flows around the immersion heating elements 431, flows into the pump 421 and then flows through the second connecting opening 414 into the second furnace chamber 411. The molten metal 401 is heated as it flows around the immersion heating elements 431. It can thus be seen that the molten metal circulates inside the melting furnace 100. The flow path runs through a type of ring channel, which comprises in particular all of the furnace chambers described.

In particular, the immersion heating elements 431 can be arranged in flow direction in three rows. Alternatively, one or more further rows or only one or two rows of immersion heating elements 431 can be provided. In this case, the immersion heating elements 431 of a first row can be arranged offset from immersion heating elements 431 of a second row. The immersion heating elements 431 of a first row can alternatively be arranged behind one another or in alignment with the immersion heating elements 431 of a second row. This is shown schematically in FIG. 4. Several immersion heating elements 431 can also be arranged downstream in alignment with one another and some further immersion heating elements 431 can be arranged downstream offset to one another.

When melt 450 has been introduced into the furnace chamber 411 through the charging opening 440, melt 450 is located in the furnace chamber 411. When the pump 421 is switched on, the molten metal 401 flows around the melt 450 located in the furnace chamber 411 and heats it so that it melts. The molten metal 401 flows from the pressure connection of the pump 431 from the connecting opening 414 through the second furnace chamber 411, flows firstly around the melt 450, then around the melt 450′ and flows through the connecting opening 413, flows around the immersion heating elements 431 in the first furnace chamber 410 and flows to the intake connection of the pump 421. The first charging opening 440 is arranged closer to the pressure connection of the pump 421 than the second charging opening 440′. As a result, the melt 450 is firstly flowed around and already partially melted before the molten metal 401, now already partially encompassing the melt 450, flows around the melt 450′ and at least partially melts it.

Alternatively or in addition to a pump 421, the circulating device 420 can comprise a stirrer for circulating the molten metal 401. The stirrer can be arranged for example outside the furnace chambers and can be electromagnetic. For example, the stirrer can be arranged underneath the furnace chambers. By applying an alternating electromagnetic field, the molten metal 401 can be set into rotation.

The exemplary embodiment of FIG. 4 can additionally comprise a second heating device (not shown). In particular, the second heating device can be arranged in the region of the second furnace chamber 411. The second heating device can in particular be an electrical heating device. In particular, the second heating device can be arranged in an area which does not come into contact with melt. In particular, the second heating device can be arranged above the melt. The second heating device can comprise second heating elements in the form of heating rods, heating plates, heating panels or heating coils. In addition or alternatively, the second heating device can comprise heating elements in the form of gas burners. The heating elements can be arranged under a ceiling of a furnace chamber, in particular one or both of the furnace chambers 410, 411. In particular, the heating rods are electrically operated. When switched on, the heating elements can radiate heat so that the melt is heated underneath the second heating elements.

FIG. 5 shows a schematic representation of a melting furnace 500 for melting metal. FIG. 5 shows the melting furnace 500 in a horizontal cross-section of the melting furnace 500 in a plan view.

The melting furnace 500 is particularly suitable for melting metals with a melting point of below 900° C. The melting furnace 500 is particularly suitable for melting lumpy charging material (melt 550), for example the size of a car wheel rim. Furthermore, the melting furnace 500 is suitable for receiving and melting several larger metal parts at the same time.

The melting furnace comprises a first furnace chamber 510 and a second furnace chamber 511. The first furnace chamber 510 and the second furnace chamber 511 are formed by furnace walls 512. A dividing wall 512′ separates the first furnace chamber 510 from the second furnace chamber 511. The first furnace chamber 510 and the second furnace chamber 511 are connected to one another fluidically via a first connecting opening 513 and a second connecting opening 514.

The melting furnace 500 has a first charging opening 540. The charging opening 540 is configured for supplying metal to be melted, in particular melt 550, in the present case a car wheel rim for example. The charging opening 540 is arranged on the furnace chamber 511 such that the melt 550 can be introduced from an environment 1 surrounding the melting furnace 500 through the charging opening 540 into the second furnace chamber 511, when the charging opening 540 is open. The charging opening 540 has a width of 60 cm and a height of 60 cm. For example, a conveyor element or a robot can be connected to the charging opening, so that charging material can be introduced automatically into the melting furnace 500. The charging opening 540 can be closed by a charging opening door 541. A furnace interior, comprising the furnace chamber 510 and the second furnace chamber 511, can be closed off from the environment 1 surrounding the melting furnace by the charging opening door 541.

The melting furnace 500 has a second charging opening 540′. The charging opening 540′ is configured for supplying metal to be melted, in particular melt 550′, in the present case for example a plurality of metal bars. The charging opening 540′ is arranged on the furnace chamber 511 such that the melt 550′ can be introduced from an environment 1 surrounding the melting furnace 500 through the charging opening 540′ into the second furnace chamber 511 when the charging opening 540′ is open. The charging opening 540′ has a width of 150 cm and a height of 120 cm. This has the advantage, that larger amounts of charging material can be introduced into the second furnace chamber at the same time. For example, the charging material can be tipped through the charging opening 540′ from a collecting container. The melt 550′ can for example be returning material from a casting process. The melting furnace can have receiving devices for such a collecting container on an outer wall. For example, a conveyor element or a robot can be connected to the charging opening, so that charging material can be introduced automatically into the melting furnace 500. The charging opening 540′ can be closed by a charging opening door 541′. A furnace interior, comprising the furnace chamber 510 and the second furnace chamber 511, can be closed off from the environment 1 surrounding the melting furnace by the charging opening door 541′.

In particular, areas of the melting furnace 500, which are configured to come into contact with molten metal, are lined with refractory material. For example, the furnace chamber 510 and the furnace chamber 511 are at least partially lined with refractory material. The areas with a refractory lining are configured to withstand temperatures of at least −50° C. and/or at least −20° C. and/or at least 0° C. The refractory-lined areas are configured to withstand temperatures of up to 5000° C. and/or up to 2000° C. and/or up to 1500° C. For this purpose, a molten metal 501 located in the melting furnace 500, in particular in the furnace chambers 510 and 511, can be heated to temperatures of at least 500° C. and/or at least 700° C. and/or at least 900° C. and/or at least 1100° C.

The melting furnace 500 can be heated electrically. The melting furnace 500 comprises a first heating device 530 with electrically heatable immersion heating elements 531, which are arranged in the furnace chamber 510. Preferably, six immersion heating elements 531 are arranged in the furnace chamber 510. The immersion heating elements 531 can be operated electrically to produce heat. The immersion heating elements 531 have a refractory surface and can be immersed in molten metal to heat it.

The furnace chambers 510 and 511 are filled at least partially with the molten metal 501, for example a molten aluminum. The molten aluminum comprises aluminum. The molten aluminum can for example be an aluminum alloy. The furnace chamber 511 contains about 20% of the molten metal 501, which is arranged in the melting furnace 500. The furnace chamber 510 contains about 80% of the molten metal 201, which is arranged in the melting furnace 500. The molten metal 501 has a temperature of about 750° C.

The melting furnace 500 comprises a circulating device 520, which is configured to produce a molten metal flow, at least partly represented by arrows 501′, inside the melting furnace 500. The circulating device 520 comprises a pump 521 for conveying the molten metal 501.

The circulating device 520 is arranged and configured such that the molten metal flow 501′ circulates between the immersion heating elements 531 and the pump 521. The pump 521 is arranged in the first furnace chamber 510. A pressure connection of the pump 521 is connected in a sealing manner to the second connecting opening 514, such that molten metal 501 that flows through the second connecting opening flows firstly through the pump 521.

An intake connection of the pump 521 is arranged facing the immersion heating elements 531. The second connecting opening 513 is arranged upstream of the immersion heating elements 531, so that the molten metal 501, which is conveyed by the pump 521, flows through the first furnace chamber 510, flows around the immersion heating elements 531, flows into the pump 521 and then flows through the second connecting opening 514 into the second furnace chamber 511. It can thus be seen that the molten metal circulates inside the melting furnace 100. The flow path runs through a type of ring channel, which comprises in particular all of the furnace chambers described.

The molten metal 501 is heated as it flows around the immersion heating elements 531. In particular, the immersion heating elements 531 can be arranged in flow direction in three rows. Alternatively, one or more further rows or only one or two rows of immersion heating elements 531 can be provided. In this case, the immersion heating elements 531 of a first row can be arranged offset from immersion heating elements 531 of a second row. The immersion heating elements 531 of a first row can alternatively be arranged behind one another or in alignment with the immersion heating elements 531 of a second row. This is shown schematically in FIG. 5. Several immersion heating elements 531 can also be arranged downstream in alignment with one another and some further immersion heating elements 531 can be arranged downstream offset to one another.

When melt 550 has been introduced into the furnace chamber 511 through the charging opening 540, melt 550 is located in the furnace chamber 511. When the pump 521 is switched on, the molten metal 501 flows around the melt 550 located in the furnace chamber 511 and heats it so that it melts. The molten metal 501 flows from the pressure connection of the pump 531 from the connecting opening 514 through the second furnace chamber 511, first flows around the melt 550 and then around the melt 550′ and flows through the connecting opening 513, flows around the immersion heating elements 531 in the first furnace chamber 510 and flows to the intake connection of the pump 521.

Alternatively or in addition to a pump 521, the circulating device 520 can comprise a stirrer for circulating the molten metal 501. The stirrer can be arranged for example outside the furnace chambers and can be electromagnetic. For example, the stirrer can be arranged underneath the furnace chambers. By applying an alternating electromagnetic field, the molten metal 501 can be set into rotation.

The exemplary embodiment of FIG. 5 can additionally comprise a second heating device (not shown). In particular, the second heating device can be arranged in the region of the second furnace chamber 511. The second heating device can in particular be an electrical heating device. In particular, the second heating device can be arranged in an area which does not come into contact with melt. In particular, the second heating device can be arranged above the melt. The second heating device can comprise second heating elements in the form of heating rods, heating plates, heating panels or heating coils. In addition or alternatively, the second heating device can comprise heating elements in the form of gas burners. The heating elements can be arranged under a ceiling of a furnace chamber, in particular one or both of the furnace chambers 510, 511. In particular, the heating rods are electrically operated. When switched on, the heating elements can radiate heat so that the melt is heated underneath the second heating elements.

FIG. 6 shows a schematic representation of a melting furnace 600 for melting metal. FIG. 6 shows the melting furnace 600 in a horizontal cross-section of the melting furnace 600 in a plan view.

The melting furnace 600 is particularly suitable for melting metals with a melting point of below 1600° C.

The melting furnace comprises a first furnace chamber 610 and a second furnace chamber 611. The first furnace chamber 610 and the second furnace chamber 611 are formed by furnace walls 612. A dividing wall 612′ separates the first furnace chamber 610 from the second furnace chamber 611. The first furnace chamber 610 and the second furnace chamber 611 are connected to one another fluidically via a first connecting opening 613 and a second connecting opening 614.

The melting furnace 600 has a first charging opening 640. The charging opening 640 is configured for feeding metal to be melted. The charging opening 640 is arranged on the furnace chamber 611 in such a way that metal to be melted can be introduced from an environment 1 surrounding the melting furnace 600 through the charging opening 640 into the second furnace chamber 611, when the charging opening 640 is opened. The charging opening 640 has a width of 120 cm and a height of 120 cm. The charging opening 640 can be closed by a charging opening door 641. A furnace interior, comprising the furnace chamber 610 and the second furnace chamber 611, can be closed off from the environment 1 surrounding the melting furnace by the charging opening door 640.

In particular, areas of the melting furnace 600, which are configured to come into contact with molten metal, are lined with refractory material. For example, the furnace chamber 610 and the furnace chamber 611 are at least partially lined with refractory material. The areas with a refractory lining are configured to withstand temperatures of at least −50° C. and/or at least −20° C. and/or at least 0° C. The refractory-lined areas are configured to withstand temperatures of up to 1500° C. and/or up to 1100° C. and/or up to 600° C. For this purpose, a molten metal located in the melting furnace, in particular in the furnace chamber 110, can be heated to temperatures of at least 300° C. and/or at least 420° C. and/or at least 600° C. and/or a maximum of 900° C.

The melting furnace 600 can be heated electrically. The melting furnace 600 comprises a first heating device 630 with electrically heatable immersion heating elements 631, which are arranged in the furnace chamber 610. Preferably, five immersion heating elements 631 are arranged in the furnace chamber 610. The immersion heating elements 631 can be operated electrically to produce heat. The immersion heating elements 631 have a refractory surface and can be immersed in molten metal to heat it.

The furnace chambers 610 and 611 are filled at least partially with the molten metal 601, for example a molten aluminum. The molten aluminum comprises aluminum. The molten aluminum can for example be an aluminum alloy. The furnace chamber 611 contains about 60% of the molten metal 601, which is arranged in the melting furnace 600. The furnace chamber 610 contains about 40% of the molten metal 601, which is arranged in the melting furnace 600. The molten metal 601 has a temperature of about 750° C.

The melting furnace 600 comprises a circulating device 620, which is configured to produce a molten metal flow, at least partly represented by arrows 601′, inside the melting furnace 600. The circulating device 620 comprises a pump 621 for conveying the molten metal 601.

The circulating device 620 is arranged and configured such that the molten metal flow 601′ circulates between the immersion heating elements 631 and the pump 621. The pump is arranged in the first furnace chamber 610. An intake connection of the pump 621 is connected to the first connecting opening in a sealing manner such that molten metal 601 flowing through the first connecting opening flows into the pump 621. A pressure connection of the pump 621 is arranged facing the immersion heating elements 631. The second connecting opening is arranged downstream of the immersion heating elements 631, so that the molten metal 601, which is conveyed by the pump, flows through the first furnace chamber, thereby flowing around the immersion heating elements 631 and then through the second connecting opening 614 into the second furnace chamber 611. It can thus be seen that the molten metal circulates inside the melting furnace 100. The flow path runs through a type of ring channel, which comprises in particular all of the furnace chambers described.

The molten metal 601 is heated as it flows around the immersion heating elements. In particular, the immersion heating elements 631 can be arranged in a row in flow direction. Alternatively, one or more further rows of immersion heating elements 631 can be provided. Here the immersion heating elements 631 of a first row can be arranged exactly under immersion heating elements 631 of a second row (similar to the arrangement of the immersion heating elements 231 and as already described with reference to FIG. 2′). The immersion heating elements of a first row can be arranged offset to the immersion heating elements of a second row (similar to the arrangement of the immersion heating elements 231 and as already described above with reference to FIG. 2″).

When melt 650 has been introduced into the furnace chamber 611 through the charging opening 640, melt 650 is located in the furnace chamber 611. When the pump 621 is switched on, the molten metal 601 flows around the melt 650 located in the furnace chamber 611 and heats it so that it melts. The molten metal 601 flows from the pump 631 driven by a pressure connection of the pump, through the first furnace chamber 610, flows around the immersion heating elements 631, flows through the connecting opening 614 into the second furnace chamber 611, flows around the melt 650 and flows to the intake connection of the pump 621 connected to the connecting opening 613.

Alternatively or in addition to the pump 621, the circulating device 620 can comprise a stirrer for circulating the molten metal. The stirrer can be arranged for example outside the furnace chambers and can be electromagnetic. For example, the stirrer can be arranged underneath the furnace chambers. By applying an alternating electromagnetic field, the molten metal 601 can be set into rotation.

A second heating device 660 is arranged in the area of the second furnace chamber 611. The second heating device can in particular be an electrical heating device. In particular, the second heating device can be arranged in an area in the furnace chamber 611 that does not come into contact with melt. In particular, the second heating device can be arranged above the melt. In the exemplary embodiment shown in FIG. 6, the second heating device 660 comprises second heating elements 661 in the form of heating rods, which are arranged under a ceiling of the second furnace chamber 611. The heating rods are electrically operated. When switched on, the heating rods radiate heat so that the melt is heated in the region of the second heating chamber 611.

FIG. 6′ corresponds to FIG. 6, wherein instead of heating rods gas burners are provided as second heating elements 661. By way of example, only one gas burner is shown. However, one single or even several gas burners can be provided. The underlying melt 601 can be heated via the gas burner. FIG. 6″ corresponds to FIG. 6, wherein gas burners are also provided as secondary heating elements 661 in addition to heating rods.

The gas burners can be arranged closer to the charging opening 640 than the heating rods. This results in a transfer of heat from the gas flame to the area close to the charging opening, in which the melt is located immediately after it has been charged. This accelerates the melting process. However, a reverse sequence (heating rods closer to the charging opening 640 than gas burners) can also be provided.

FIG. 7 shows a schematic representation of a melting furnace 700 for melting metal. FIG. 7 shows the melting furnace 700 in a horizontal cross-section of the melting furnace 700 in a plan view.

The melting furnace 700 is particularly suitable for melting metals with a melting point of below 900° C. The melting furnace 700 is particularly suitable for melting lumpy charging material (melt 750), for example the size of a car wheel rim. Furthermore, the melting furnace 700 is suitable for receiving and melting several larger metal parts at the same time.

The melting furnace comprises a first furnace chamber 710 and a second furnace chamber 711. The first furnace chamber 710 and the second furnace chamber 711 are formed by furnace walls 712. A dividing wall 712′ separates the first furnace chamber 710 from the second furnace chamber 711. The first furnace chamber 710 and the second furnace chamber 711 are connected to one another fluidically via a first connecting opening 713 and a second connecting opening 714.

The melting furnace 700 has a first charging opening 740. The charging opening 740 is configured for supplying metal to be melted, in particular melt 750, in the present case a car wheel rim for example. The charging opening 740 is arranged on the furnace chamber 711 such that the melt 750 can be introduced from an environment 1 surrounding the melting furnace 700 through the charging opening 740 into the second furnace chamber 711, when the charging opening 740 is open. The charging opening 740 has a width of 120 cm and a height of 120 cm. For example, a conveyor element or a robot can be connected to the charging opening, so that charging material can be introduced automatically into the melting furnace 700. The charging opening 740 can be closed by a charging opening door 741. A furnace interior, comprising the furnace chamber 710 and the second furnace chamber 711, can be closed off from the environment 1 surrounding the melting furnace by the charging opening door 740.

The melting furnace 700 has a second charging opening 740′. The charging opening 740′ is configured for supplying metal to be melted, in particular melt 750′, in the present case for example a plurality of metal bars. The charging opening 740′ is arranged on the furnace chamber 711 such that the melt 750′ can be introduced from an environment 1 surrounding the melting furnace 700 through the charging opening 740′ into the second furnace chamber 711 when the charging opening 740′ is open. The charging opening 740′ has a width of 100 cm and a height of 100 cm. This has the advantage that larger quantities of charging material can be introduced into the second furnace chamber at the same time. For example, the charging material can be tipped through the charging opening 740′ from a collecting container. The melt 750′ can for example consist of return material from a casting process. The melting furnace can have receiving devices for such a collecting container on an outer wall. For example, a conveyor element or a robot can be connected to the charging opening, so that charging material can be introduced automatically into the melting furnace 700. The charging opening 740′ can be closed by a charging opening door 741′. A furnace interior, comprising the furnace chamber 710 and the second furnace chamber 711, can be closed off from the environment 1 surrounding the melting furnace by the charging opening door 741′.

In particular, areas of the melting furnace 700, which are configured to come into contact with molten metal, are lined with refractory material. For example, the furnace chamber 710 and the furnace chamber 711 are at least partially lined with refractory material. The areas with a refractory lining are configured to withstand temperatures of at least −50° C. and/or at least −20° C. and/or at least 0° C. The refractory-lined areas are configured to withstand temperatures of up to 1500° C. and/or up to 1100° C. and/or up to 600° C. For this purpose, a molten metal located in the melting furnace, in particular in the furnace chamber 110, can be heated to temperatures of at least 300° C. and/or at least 420° C. and/or at least 600° C. and/or a maximum of 900° C.

The melting furnace 700 can be heated electrically. The melting furnace 700 comprises a first heating device 730 with electrically heatable immersion heating elements 731, which are arranged in the furnace chamber 710. Preferably, six immersion heating elements 731 are arranged in the furnace chamber 710. The immersion heating elements 731 can be operated electrically to produce heat. The immersion heating elements 731 have a refractory surface and can be immersed in molten metal to heat it.

The furnace chambers 710 and 711 are filled at least partially with the molten metal 701, for example a molten aluminum. The molten aluminum comprises aluminum. The molten aluminum can for example be an aluminum alloy. The furnace chamber 711 contains about 20% of the molten metal 701, which is arranged in the melting furnace 700. The furnace chamber 710 contains about 80% of the molten metal 201, which is arranged in the melting furnace 700. The molten metal 701 has a temperature of about 750° C.

The melting furnace 700 comprises a circulating device 720, which is configured to produce a molten metal flow, at least partly represented by arrows 7011, inside the melting furnace 700. The circulating device 720 comprises a pump 721 for conveying the molten metal 701.

The circulating device 720 is arranged and configured such that the molten metal flow 701′ circulates between the immersion heating elements 731 and the pump 721. The pump 721 is arranged in the first furnace chamber 710. A pressure connection of the pump 721 is connected in a sealing manner to the second connecting opening 714, such that molten metal 701 that flows through the second connecting opening flows firstly through the pump 721. An intake connection of the pump 721 is arranged facing the immersion heating elements 731. The second connecting opening 713 is arranged upstream of the immersion heating elements 731, so that the molten metal 701, which is conveyed by the pump 721, flows through the first furnace chamber 710, flows around the immersion heating elements 731, flows into the pump 721 and then flows through the second connecting opening 714 into the second furnace chamber 711. It can thus be seen that the molten metal circulates inside the melting furnace 100. The flow path runs through a type of ring channel, which comprises in particular all of the furnace chambers described.

The molten metal 701 is heated as it flows around the immersion heating elements 731. In particular, the immersion heating elements 731 can be arranged in flow direction in three rows. Alternatively, one or more further rows or only one or two rows of immersion heating elements 731 can be provided. In this case, the immersion heating elements 731 of a first row can be arranged offset to the immersion heating elements 731 of a second row. The immersion heating elements 731 of a first row can alternatively be arranged behind one another or in alignment with the immersion heating elements 731 of a second row. This is shown schematically in FIG. 7. Several immersion heating elements 731 can also be arranged downstream in alignment with one another and several further immersion heating elements 731 can be arranged offset to one another downstream.

The charging opening 740 is located directly behind the connecting opening 714 in the flow direction. When melt 750 has been introduced into the furnace chamber 711 through the charging opening 740, melt 750 is located in the furnace chamber 711. When the pump 721 is switched on, the molten metal 701 flows around the melt 750 located in the furnace chamber 711 and heats it so that it melts. Here the molten metal 701 flows from the pressure connection of the pump 731 from the connecting opening 714 into the second furnace chamber and firstly flows around the melt 750. The charging opening 740′ is located in flow direction behind the connecting opening 714 and behind the charging opening 740. Once the molten metal 101 has flowed around the melt 750, it flows around the melt 750′, which was introduced via the charging opening 740′. When flowing through the second furnace chamber 711 the molten metal 701 thus first flows around the melt 750 and then around the melt 750′ and then flows through the connecting opening 713, flows around the immersion heating elements 731 in the first furnace chamber 710 and flows to the intake connection of the pump 721.

A second heating device 760 is arranged on a ceiling in a ceiling area of the second furnace chamber 711. The second heating device 760 is an electrical heating device. The second heating device 760 is arranged in an area which does not come into contact with melt, namely on a furnace chamber ceiling. The second heating device 760 is arranged above the melt. The second heating device comprises four second heating elements 761 in the form of heating rods. In addition or alternatively, the second heating device can comprise heating elements in the form of gas burners. The heating elements can be arranged under a ceiling of a furnace chamber, in particular one or both of the furnace chambers 710, 711. When switched on the heating elements 761 radiate heat so that the melt 701 is heated below the second heating element 761. The heating elements 761 are arranged downstream behind the second charging opening 740′.

Alternatively or in addition to a pump 721, the circulating device 720 can comprise a stirrer for circulating the molten metal 701. The stirrer can be arranged for example outside the furnace chambers and can be electromagnetic. For example, the stirrer can be arranged underneath the furnace chambers. By applying an alternating electromagnetic field, the molten metal 701 can be set into rotation.

FIG. 8 shows a schematic, perspective view of a melting furnace 800, which is shown partially in cross-section to illustrate the interior of a furnace. The melting furnace 800 can be filled with a molten metal. The melting furnace 800 shown has a first furnace chamber 810 in which a first heating device 830 comprising immersion heating elements 831 are arranged. The immersion heating elements 831, one of which is denoted for example by the reference sign 831, are electrical heating elements. A second furnace chamber 811 is provided which is fluidically connected to the first furnace chamber 810. The melting furnace 800 comprises further furnace chambers 811′, 811″ and 811′″, which are also fluidically connected to the first furnace chamber 810 and the second furnace chamber 811. A circulating device 820 is arranged in a furnace chamber 811′ which is located upstream of the furnace chamber 811. The circulating device 820 comprises a pump 821. A pressure connection (i.e. a pressure side) of the pump 821 faces the furnace chamber 811, an intake connection (i.e. an intake side) of the pump 821 faces the furnace chamber 810. The pump 821 circulates a molten metal located in the furnace interior, so that it is conveyed from the first furnace chamber into the furnace chamber 811′ with their pump 821 and from there into the second furnace chamber 811, from where it flows back through a furnace chamber 811′″ into the first furnace chamber 810. It can thus be seen that the molten metal circulates inside the melting furnace 100. The flow path runs through a type of ring channel, which comprises in particular all of the furnace chambers described.

The dimensions of the furnace chamber 810, 811, 811′, 811″, 811′″ are given by way of example. In particular, the furnace chamber 811 can have smaller dimensions. In particular, it can only have relatively large dimensions if its charging opening 840 is sufficiently large to accommodate any return parts (i.e. defective casting parts to be remelted).

A charging opening 840 for introducing melt is provided on the second furnace chamber 811. The charging opening 840 is in the upper half of the vertical height of the second furnace chamber 811. A second charging opening 840′ is provided on a furnace chamber 811″. The second charging opening 840′ is smaller than the first charging opening 840. The first charging opening 840 is suitable for larger metals parts to be introduced, for example with a size of at least 40 cm and at most 300 cm, and the second charging opening 840′ is suitable for bulk material, for example metal shavings with a maximum length of for example a maximum of 10 cm and a maximum minimum length of 0.5 mm. The furnace chamber 811′″, which is arranged in flow direction between the second furnace chamber 811 and the first furnace chamber 810, is configured as an impurity collection chamber. An opening (not shown) is provided in the region of the lower depression of the furnace chamber for connecting a tap valve. In the second furnace chamber 811 a second heating device 860 is arranged on a ceiling. The heating device comprises heating elements 861, which are configured as electrical heating rods. In addition or alternatively, the heating rods can also be configured as gas burners. The melting furnace also has a removal pocket 811′, which is arranged on the chamber 811′^{v} and is connected thereto in a fluidic manner. Furthermore, a cleaning opening 870 (see FIG. 11) is provided on the furnace chamber 811. The cleaning opening 870, the charging openings 840 and 840′ each have a lid or a door for closing, but these are not indicated in FIG. 8.

FIG. 9 shows the melting furnace 800 of FIG. 8 in cross-section in a plane defined by the lines A and B indicated in FIG. 8.

In the Figures recurring features are denoted by the same reference signs.

FIG. 9 shows the furnace chamber 811, the furnace chamber 811′″, the furnace chamber 810 and furnace chamber 811″ in cross-section. In the furnace chamber 811, the heating elements 861 arranged on the ceiling of the furnace chamber 811 can be seen in the form of heating rods. The pump 821 conveys molten metal in the direction indicated by the arrow 801′ through the furnace chambers. The molten metal is pumped by the pump 821 through an inflow opening 814 into the second furnace chamber 811. FIG. 10 again shows an enlarged view of a section of FIG. 8 or 9 to illustrate the furnace chamber 811′″. The furnace chamber 811′″, i.e. the impurity collection chamber, comprises a sunken area in the form of a bottom depression 8112. A bottom 8113 of an inflow area of the furnace chamber 811′″ is at the same level as a bottom 8114 of the furnace chamber 811 in the outflow section of the furnace chamber 811. Behind the inflow area of the furnace chamber 811″, a depression 8112 is formed in the furnace chamber 811′. Sediments can pass from the furnace chamber 811 into the furnace chamber 811′ and are deposited in the depression 8112. A bottom 8115 of an outflow opening of the furnace chamber 811″ is arranged above a bottom of the depression 8112 so that the sediments cannot or can only partially enter the downstream furnace chamber 810. The bottom of the furnace chamber 810 is at the same level as the floor 8115 of the discharging opening of the furnace chamber 811″.

FIG. 10 shows an optional maximum filling level kₘₐₓ and an optional minimum filling level kₘᵢₙ. The filling levels indicate a possible minimum or maximum filling height of molten metal, which ensures that the furnace operates properly. When the furnace chamber 811 is heated electrically and not with burners which produce waste gases, the opening for the melt to the furnace chamber 811′″ can end above the maximum filling level kₘₐₓ of the melt in the furnace because no waste gases are emitted. Thus, impurities on the melt surface can be conveyed from furnace chamber 811 to furnace chamber 811″ at any filling level. During the melting operation of the furnace, these impurities are continuously conveyed from the first chamber to the furnace chamber 811′ by the melt circulation; this also applies to the sediments in the first chamber. A weir in the outflow area of the furnace chamber 811′ retains the impurities on the melt surface and allows them to be skimmed off. The sediments are retained by the bottom recess 8112. At the lowest point of the recessed area 8112, an outflow valve (not shown) is arranged. A conveying direction of the molten metal is indicated again in FIG. 10 by the arrow 801′.

FIG. 11 shows a cross-section of the furnace chamber 811 in vertical direction along line C shown in FIG. 8. The charging opening 840 is clearly shown. A charging opening door (not shown) is arranged at the charging opening 840 for closing the charging opening. The cleaning opening 870 is closed by a cleaning opening door 870′. The arrows 801′ show schematically the flow of the molten metal from the inflow opening 814 in the direction of the outflow opening 813. An outer wall of the furnace chamber 811, on which the charging opening 840 is formed, can be configured as an inclined plane (also referred to as a cleaning slope) 8401 (as shown in FIG. 11).

FIG. 12 shows an alternative embodiment of the furnace chamber 811 of the melting furnace 800 of FIGS. 8-11. At the charging opening 840, in addition to or as an alternative to the cleaning slopes 8401, a charging ramp 8402 can be formed. The charging ramp 8402 is arranged in particular above a molten metal filling level k. Thus metal parts can be dried on the charging ramp 8402. Above the charging ramp 8402 one or more gas burners 862 can be provided for heating the metal arranged on the charging ramp 8402, as shown in FIG. 13 for example.

In the furnace chamber 811, a gas-circulating device 880 can be provided in addition or as an alternative. This is shown in FIG. 14. The gas-circulating device 880 can comprise a blower 881. This can be configured and arranged such that furnace atmosphere is removed from a first area of the furnace chamber 811 and blown in again in the region of the charging ramp 8402. In particular, air heated by the heating element 861 in the region of the charging ramp 8402, in particular above the charging ramp, can be blown back into the furnace inner region. The arrows 802′ indicate a gas-circulation direction of the gas-circulating device 880.

FIG. 15 shows a cross-section of the second furnace chamber of the melting furnace of FIGS. 8 to 14, wherein gas burners 861′ are provided instead of electrical heating elements 861.

FIG. 16 shows a schematic representation of a melting furnace 1500 for melting metal. FIG. 16 shows the melting furnace 1500 in a horizontal cross-section of the melting furnace 1500 in a plan view.

The melting furnace 1500 is suitable in particular for melting metals with a melting point of below 1200° C. The melting furnace 1500 is particularly suitable for melting lumpy charging material (melt 1550), for example the size of a car wheel rim. Furthermore, the melting furnace 1500 is suitable for receiving and melting several larger metal parts at the same time.

The melting furnace comprises a first furnace chamber 1510 and a second furnace chamber 1511. The first furnace chamber 1510 and the second furnace chamber 1511 are formed by furnace walls 1512. A dividing wall 1512′ separates the first furnace chamber 1510 from the second furnace chamber 1511. The dividing wall arranged in this case such that it forms an inner region 15121. The first furnace chamber 1510 and the second furnace chamber 1511 are connected to one another fluidically by a first connecting opening 1513 and a second connecting opening 1514.

The melting furnace 1500 has a first charging opening 1540. The charging opening 1540 is configured to supply metal to be melted, in particular melt 1550, in the present case for example a car wheel rim. The charging opening 1540 is arranged on the furnace chamber 1511 such that the melt 1550 can be introduced from an environment 1 surrounding the melting furnace 1500 through the charging opening 1540 into the second furnace chamber 1511 when the charging opening 1540 is open. The charging opening 1540 has a width of 60 cm and a height of 60 cm. For example, a conveyor or a robot can be connected to the charging opening so that charging material can be introduced automatically into the melting furnace 1500. The charging opening 1540 can be closed by a charging opening door 1541. A furnace inner region, comprising the furnace chamber 1510, can be closed off by the charging opening door 1541 from the environment 1 surrounding the melting furnace.

The charging opening 1540 and/or 1540′ and/or 1540″ for the charging parts can be arranged vertically or almost vertically. That is, an angle between the vertical and the plane of the charging opening can be in particular less than 45°, preferably less than 25° and/or equal to 0° or greater than 0°.

The charging opening 1540 and/or 1540′ and/or 1540″ can be arranged to be horizontal or almost horizontal, so that the charging parts can be added to the melt from above. This means than an angle between the horizontal and the plane of the charging opening can be in particular less than 45°, preferably less than 25° and/or equal to 0° or greater than 0°. The lid of the charging opening can then be a cover, which is pivoted upwards to reveal the corresponding charging opening 1540 and/or 1540′ and/or 1540″. One or more of the charging openings can be arranged horizontally as described above and one or more charging openings can be arranged vertically as described above.

For charging a collection of charging parts, which for example are pushed or tipped from a charging container into the melt, the width of the charging chamber can be greater than the width of the inflow opening or the outflow opening of the corresponding furnace chamber. This is shown in FIG. 16 as an example of the charging chamber 1511 at the charging opening 1540′.

The melting furnace 1500 has a second charging opening 1540′. The charging opening 1540′ is configured for supplying metal to be melted, in particular melt 1550′, in the present case for example a plurality of metal bars. The charging opening 1540′ is arranged on the furnace chamber 1511 in such a way that the melt 1550′ can be introduced from an environment 1 surrounding the melting furnace 1500 through the charging opening 1540′ into the second furnace chamber 1511, when the charging opening 1540′ is open. The charging opening 1540′ has a width of 150 cm and a height of 120 cm. This has the advantage that larger quantities of charging material can be introduced into the second furnace chamber at the same time. For example, the charging material can be tipped through the charging opening 540′ from a collecting container. The melt 1550′ can be for example in the form of returns from a casting process. The melting furnace 1500 can comprise receiving devices for such a collecting container on an outer wall. For example, a conveyor or a robot can be connected to the charging opening so that charging material can be introduced automatically into the melting furnace 1500. The charging opening 1540′ can be closed by a charging opening door 1541′. A furnace inner region, comprising the furnace chamber 1510 and the second furnace chamber 1511, can be closed off from the environment 1 surrounding the melting furnace 1500 by means of the charging opening door 1541′.

The melting furnace 1500 has a third charging opening 1540″. The charging opening 1540″ is configured to supply metal to be melted, in particular melt 1550″, in the present case for example metal shavings. The charging opening 1540″ is arranged on the furnace chamber 1511 such that the melt 1550″ can be introduced from an environment 1 surrounding the melting furnace 1500 through the charging opening 1540″ into the second furnace chamber 1511, when the charging opening 1540″ is open. The melt 1550″ can for example be in the form of metal shavings. The charging opening 1540″ can be closed by a charging opening door 1541″. A furnace inner region, comprising the furnace chamber 1510 and the second furnace chamber 1511, can be closed optionally by the charging opening door 1541″ from the environment 1 surrounding the melting furnace 1500. It should be noted that in particular due to the areas a with a reduced flow cross-section in front of and behind the charging opening 1540″ a charging opening door is not absolutely necessary however.

In particular, areas of the melting furnace 1500, which are configured to come into contact with molten metal are provided with a refractory lining. For example, the furnace chamber 1510 and the furnace chamber 1511 are provided at least in some sections with a refractory lining. The areas with a refractory lining are configured to withstand temperatures of at least −50° C. and/or at least −20° C. and/or at least 0° C. The refractory-lined areas are configured to withstand temperatures of up to 5000° C. and/or up to 2000° C. and/or up to 1500° C. For this purpose, a molten metal 1501 in the melting furnace 500, in particular in the furnace chambers 1510 and 1511, can be heated to temperatures of at least 500° C. and/or at least 700° C. and/or at least 900° C. and/or at least 1100° C.

In the dark-marked areas a, a flow cross-section is reduced, wherein these areas are located upstream of the charging openings.

The melting furnace 1500 can be heated electrically. The melting furnace 1500 comprises a first heating device 1530 with electrically heatable immersion heating elements 1531 which are arranged in the furnace chamber 1510. Preferably, six immersion heating elements 1531 are arranged in the furnace chamber 1510. The immersion heating elements 1531 can be operated electrically to generate heat. The immersion heating elements 1531 have a refractory surface and can be immersed in molten metal in order to heat it.

The furnace chambers 1510 and 1511 are filled at least partially with the molten metal 1501, for example a molten aluminum. The molten aluminum comprises aluminum. The molten aluminum can for example be an aluminum alloy. The furnace chamber 1511 contains about 80% of the molten metal 1501 which is arranged in the melting furnace 1500. The furnace chamber 1510 contains about 20% of the molten metal 201 which is arranged in the melting furnace 1500. The molten metal 1501 has a temperature of about 750° C.

The melting furnace 1500 comprises a first circulating device 1520, which is configured to produce a molten metal flow, represented at least partly by the arrows 1501′, inside the melting furnace 1500. The circulating device 1520 comprises a pump 1521 for conveying the molten metal 1501. The melting furnace 1500 comprises a second circulating device 1520′, which is configured to produce a molten metal flow, represented at least partly by the arrows 1501′, inside the melting furnace 1500. The circulating device 1520′ comprises a pump 1521′ for conveying the molten metal 1501.

The circulating device 1520 is arranged and configured such that the molten metal flow 1501′ circulates between the immersion heating elements 1531 and the pump 1521. The pump 1521 is arranged in the first furnace chamber 1510. A pressure connection of the pump 1521 is connected to the second connecting opening 1514 such that molten metal 1501 flowing through the second connecting opening 1514 flows firstly through the pump 1521. An intake connection of the pump 1521 is arranged facing the immersion heating elements 1531. The second connecting opening 1513 is arranged upstream of the immersion heating elements 1531, so that the molten metal 1501 conveyed by the pump 1521 flows through the first furnace chamber 1510, flows around the immersion heating elements 1531, flows into the pump 1521 and then flows through the second connecting opening 1514 into the second furnace chamber 1511. It can thus be seen that the molten metal circulates inside the melting furnace 100. The flow path runs through a type of ring channel, which comprises in particular all of the furnace chambers described.

The molten metal 1501 is heated by flowing around the immersion heating elements 1531. In particular, the immersion heating elements 1531 can be arranged in a row in flow direction. Alternatively, there can be one or more further rows or only one or two rows of immersion heating elements 1531. Here, the immersion heating elements 1531 of a first row can be arranged offset to immersion heating elements 1531 of a second row. Alternatively, the immersion heating elements 1531 of a first row may be arranged one behind the other or in alignment with the immersion heating elements 1531 of a second row. Some immersion heating elements 1531 can also be arranged in alignment with one another downstream and some other immersion heating elements 1531 can be arranged offset to one another downstream. The second circulating device 1520′, in particular the second pump 1521′, is arranged downstream of the first circulating device. The second pump 1521′ is arranged in particular between the charging opening 1540″ and the charging opening 1540′.

The first circulating device 1520′ increases the pressure of the melt to compensate for the pressure loss for example of specially shaped flow troughs or flow elements that are necessary, for example for the immersion melting of metal chips. The second circulating device 1520′ is optional. The melting furnace 1500 may also be configured without the second circulating device. The melting furnace may include special flow troughs to increase or decrease the pressure of the melt.

Preferably, a impurity collection chamber 1511′ is arranged downstream of one or more or all charging openings 1540 and/or 1540′ and/or 1540″. The impurity collection chamber can be configured similarly to the furnace chamber 811′″ described in relation to the melting furnace 800. The impurity collection chamber can comprise a closable opening for the removal of impurities.

When the melt 1550 has been placed into the furnace chamber 1511 through the charging opening 1540″, the melt 1550″ is located in the furnace chamber 1511. When the pump 1521 is switched on, the molten metal 1501 flows around the melt 1550 in the furnace chamber 1511 and heats it so that it melts. Here, the molten metal 1501 flows from the pressure connection of the pump 1521 from the connecting opening 1514 through the second furnace chamber 1511, first flowing around the melt 1550″ and then the 1550′ and then the melt 1550 and flows through the connecting opening 1513, flows around the immersion heating elements 1531 in the first furnace chamber 1510 and flows to the suction nozzle of the pump 1521. Between the charging opening 1540″ and 1540′, the pump 1521′ can be arranged such that a pressure connection points to the charging opening 1540′ and an intake connection to the charging opening 1540′.

Alternatively, or in addition to a pump 1521, the circulating device 1520 can comprise a stirrer for circulating the molten metal 1501. The stirrer can be arranged for example outside the furnace chambers and can be electromagnetic. For example, the stirrer can be arranged underneath the furnace chambers. By applying an alternating electromagnetic field, the molten metal 1501 can be set into rotational movement.

The exemplary embodiment of FIG. 16 can additionally comprise a second heating device (not shown). In particular, the second heating device can be arranged in the region of the second furnace chamber 1511. The second heating device can in particular be an electrical heating device. In particular, the second heating device can be arranged in an area which does not come into contact with melt. In particular, the second heating device can be arranged above the melt. The second heating device can comprise second heating elements in the form of heating rods. In addition or alternatively, the second heating device can comprise heating elements in the form of gas burners. The heating elements can be arranged under a ceiling of a furnace chamber, in particular one or both of the furnace chambers 1510, 1511. In particular, the heating rods are electrically operated. When switched on, the heating elements can radiate heat so that the melt is heated underneath the second heating elements.

It should be noted, that features which are disclosed with reference one of the exemplary embodiments can be combined with another exemplary embodiment, even if this is not explicitly described in the description of the corresponding exemplary embodiment.

FIG. 17 shows a cross-sectional view of a melting furnace 1700 for melting metal according to a further exemplary embodiment. The cross-sectional plane extends horizontally in space and for example approximately halfway up the vertical height of the melting furnace 1700. The melting furnace 1700 comprises a furnace housing 1703, which surrounds an annular melt channel (ring channel) 1710. More specifically, the melting furnace 1700 has refractory-lined walls 1701, which are located in the furnace housing 1703. The refractory-lined side walls 1701 and the bottom shown form the annular melt channel 1710, which is enclosed by the furnace housing 1703 (i.e. surrounded).

The ring channel 1710 is rectangular for example. A molten metal flow circulates in the ring channel 1710. For example, flow arrows 1702 indicate a flow direction, which can also run in the opposite direction. The flow arrows 1702 also indicate a breach of a partition wall in the ring channel 1710, which is located outside the cross-section plane, by means of which the ring channel 1710 has a continuous or closed ring shape.

The ring channel 1710 (and the furnace housing 1703) extends around an inner region 1752 of the melting furnace 1700. This inner region 1752 is preferably free of furnace components, with the exception of any components which may be fixed to the furnace housing 1701. The inner region 1752 is generally accessible for maintenance work and is sufficiently large for maintenance staff to enter.

The ring channel 1710 comprises a circulating device 1720 preferably in the form of a pump. This conveys a molten metal, for example clockwise or counter-clockwise through the ring channel 1710.

The ring channel 1710 also comprises heating devices 1730 each with five immersion heating elements 1731 for example. All of the immersion heating elements 1731 are offset transversely to a flow direction (see arrow 1702) and are thus positioned outside the flow shadows of the respective other immersion heating elements 1731.

The ring channel 1710 also comprises a charging opening, not shown separately, which is positioned directly above a charging material melting area 1750.

The ring channel 1710 has several straight areas 1712, which are each angled relative to adjacent straight areas 1712, here by way of example by about 90°. The straight areas 1712 are connected to one another by deflection areas 1714. An inner wall 1711 of the ring channel 1710 is rounded or chamfered in the area of the deflection areas 1714, as explained in more detail below.

A bottom weir 1740 is positioned in or adjacent to at least some of the deflection areas 1714. This defines a height level within the ring channel 1710 and in particular an elevation of the channel bottom in or adjacent to the deflection areas 1714. This reduces a free wall surface on the inner wall 1711 in the region of the deflection areas 1714, on which the molten metal can lie. In other words, the ring channel 1710 is divided into straight sections up to the height of the bottom weirs 1740. This helps to reduce stress peaks, which may occur more frequently as a result of a potentially solidifying molten metal on non-straight wall areas of the ring channel 1710.

To allow the melt to drain completely from the ring channel 1710, the bottom weirs 1740 each have connecting channels 1742 that extend in flow direction. These are configured as incisions down to a channel bottom inside the e.g. block-like bottom weirs 1740. A contraction of the solidifying melt can also lead to increased stresses on these connecting channels 1742, but any damage is less relevant on the bottom weirs 1740 than on the deflection area 1714 (and more precisely than at the corners of the inner walls inside the deflection areas 1714). In addition, the stresses on the bottom weirs 1740 can be relieved by the plastic deformation of the metal, because the amount of metal in the connecting channels 1742 is less than at the corners mentioned above.

In FIG. 17 the corners 1715 of some of the deflection areas 1714 are marked, wherein these corners 1715 are chamfered to additionally reduce stress peaks in a solidifying molten metal. For example, only the inner corners 1715 of the inner wall 1711 and/or close to the inner region 1752 are chamfered accordingly, as higher stresses occur there. A further advantage of the chamfered inner corners 1715 is a reduction in the flow dead zones downstream of the corners 1715 and a reduction in flow separation in the region of the corners 1715.

FIG. 18 shows a subdivision of the melting furnace 1700 from FIG. 17 into individual modules, which are numbered 1-12. The modules 1-12 are arranged in a row in a flow direction through the ring channel 1710. Each module 1-12 is connected in a fluid-tight manner to an upstream and downstream module 1-12 in the flow direction. Depending on the desired furnace configuration, the modules 1-12 can be selected flexibly, arranged flexibly and connected to one another. In detail, the following modules are provided: number 1: module with circulation pump; number 2: module with vertical charging opening, i.e. which in particular allows metal to be supplied along an at least approximately horizontal axis, as the charging opening itself lies in a vertical spatial plane, number 3: module with opening for skimming the melt surface (comparable to or comprising an impurity collection chamber, as disclosed here); number 4, 5, 6, 8, 9, 10: modules with immersion heating elements; number 7: module with horizontal charging opening, i.e. which in particular allows metal to be supplied along an at least approximately vertical axis, since the charging opening itself lies in a horizontal spatial plane, number 11: corner module; number 12: module for molten metal extraction.

FIG. 19 shows an alternative configuration of a melting furnace 100 according to a further exemplary embodiment, wherein the melting furnace 100 is composed of exactly two modules 1-2. The modules 1, 2 each have a rectangular form open on one side, e.g. with respect to their outer contour in the shown plan view. On one of its longitudinal sides and in particular at both ends thereof, each module 1, 2 has connecting areas 2000 for fluid-tight and mechanical connection to the other respective module 1, 2. The connecting areas 2000 each comprise an opening, by means of which melt can be exchanged with the corresponding other module 1, 2. Depending on the flow direction, this opening functions as an inflow or outflow opening. The connecting areas 2000 also comprise respective flange areas 2010, which are used as interfaces for connecting the connecting areas 2000 to one another. The flange areas 2010 can e.g. extend annularly around the outside of the furnace housing, comprised by modules 1, 2, close to the connecting areas 2000.

Again it can be seen that the modules 1, 2 define a ring channel 2012, which extends around a free inner region 2014. Furthermore, one of the modules 1 comprises a circulating device 2016 and by way of example both modules 1, 2 comprise immersion heating elements 2018. A position of a metal supply via a non-specific charging opening is indicated by an arrow 2020. A position of melt extraction via a non-specific tapping opening, melt extraction pump or other device is indicated by an arrow 2022.

Transport to the installation site can be facilitated by dividing the melting furnaces into two modules 1, 2. In particular, a width dimension of the individual modules 1, 2, extending vertically in the plan view of FIG. 19, can be significantly reduced with respect to the melting furnace formed thereby.

FIG. 20 shows an alternative configuration of a melting furnace 100 according to a further exemplary embodiment, wherein the melting furnace 100 is composed of exactly four modules 1-4. Two of the modules 1,2 are configured similar to the variant from FIG. 19, but are not directly connected to one another. Instead of this, they are indirectly connected to one another via further modules 3, 4, wherein each of the further modules 3, 4 in the plan view from FIG. 20 defines a section of a vertically extending transverse side of the melting furnace. By way of example only, these further modules 3, 4 define comparatively shorter sections of the ring channel 2012 and both of the further modules 3, 4 comprise immersion heating elements 2018. The further modules 3, 4 also each have connecting areas 2000 and flange areas 2010 of the aforementioned kind.

The volume of the ring channel 2012 and thus the capacity of the melting furnace can be increased by the further modules 3, 4. This relates in particular to a melting capacity from the additional immersion heating elements 2018 of the further modules 3, 4.

FIG. 21 shows a view of a single module 1780 of the melting furnace 1700 from FIGS. 17 & 18, wherein the single module 1780 comprises a lid-lifting device 1790. Firstly, it can be seen that the single module 1780, like each of the modules 1-12 from FIG. 18, comprises an inflow opening 1792 and an outflow opening 1794 facing away from the viewer. Depending on the flow direction, the functional assignment of the inflow and outflow can alternate between the openings 1792, 1794. Flow arrows 1702 through the single module 1780 are indicated in FIG. 21 by way of example.

The single module 1780 comprises a lid 1796. The immersion heating element 1731 is secured to the latter for example, so that the single module 1780 corresponds e.g. to the module 4 of FIG. 18. The lid 1796 can be lifted by means of the lid-lifting device 1790, for example by an electric motor or hydraulically, in a vertical direction. The lid-lifting device 1790 faces the inner region 1752 from FIG. 17 and is accessible from the latter for maintenance purposes. The immersion heating element 1731 lifted together with the lid 1796 can however be accessible from an exterior of the melting furnace 1700. The immersion heating element 1731 is therefore more easily accessible than the lid-lifting device 1790, which take into account its shorter maintenance intervals.

By arranging the lid-lifting device 1790 on one side of the single module 1780 (here: the inner side) work is not hindered from the corresponding other side (here: the outer side) on the melt surface (e.g. for the removal of impurities) and/or on the immersion heating elements 1731 by the lid-lifting device 1790.
1 melting furnace environment
100 melting furnace
101 molten metal
101′ molten metal flow
110 furnace chamber
111 second furnace chamber
120 circulating device
121 pump
130 first heating device
131 immersion heating element
140 first charging opening
141 charging opening door
200 melting furnace
201 molten metal
201′ molten metal flow
210 furnace chamber
211 second furnace chamber
212 furnace wall
212′ dividing wall
213 first connecting opening
214 second connecting opening
220 circulating device
221 pump
230 first heating device
231 immersion heating element
240 first charging opening
241 charging opening door
250 melt
300 melting furnace
301 molten metal
301′ molten metal flow
310 furnace chamber
311 second furnace chamber
312 furnace wall
312′ dividing wall
313 first connecting opening
314 second connecting opening
320 circulating device
321 pump
330 first heating device
331 immersion heating element
340 first charging opening
341 charging opening door
350 melt
400 melting furnace
401 molten metal
401′ molten metal flow
410 furnace chamber
411 second furnace chamber
412 furnace wall
412′ dividing wall
413 first connecting opening
414 second connecting opening
420 circulating device
421 pump
430 first heating device
431 immersion heating element
440 first charging opening
440′ second charging opening
441 first charging opening door
441′ second charging opening door
450 melt (metal shavings)
450′ melt (car wheel rim)
500 melting furnace
501 molten metal
501′ molten metal flow
510 furnace chamber
511 second furnace chamber
512 furnace wall
512′ dividing wall
513 first connecting opening
514 second connecting opening
520 circulating device
521 pump
530 first heating device
531 immersion heating element
540 first charging opening
540′ second charging opening
541 first charging opening door
541′ second charging opening door
550 melt (car wheel rim)
550′ melt (metal to be melted, e.g. metal bars)
600 melting furnace
601 molten metal
601′ molten metal flow
610 furnace chamber
611 second furnace chamber
612 furnace wall
612′ dividing wall
613 first connecting opening
614 second connecting opening
620 circulating device
621 pump
630 first heating device
631 immersion heating element
640 first charging opening
641 charging opening door
650 melt
660 second heating device
661 second heating elements
700 melting furnace
701 molten metal
701′ molten metal flow
710 furnace chamber
711 second furnace chamber
712 furnace wall
712′ dividing wall
713 first connecting opening
714 second connecting opening
720 circulating device
721 pump
730 first heating device
731 immersion heating element
740 first charging opening
740′ second charging opening
741 first charging opening door
741′ second charging opening door
750 melt (car wheel rim)
750′ melt (metal to be melted, e.g. metal bars)
760 second heating device
761 second heating elements
800 melting furnace
810 furnace chamber
811 second furnace chamber
811′ further furnace chamber
811″ further furnace chamber
811′″ further furnace chamber
811′^{v} tapping pocket
8112 depression
8113 bottom inflow section of furnace chamber 811′″
8114 bottom outflow section of furnace chamber 811
8115 bottom of outflow opening of furnace chamber 811′″
813 outflow opening
814 inflow opening
820 circulating device
821 pump
830 first heating device
831 immersion heating element
840 first charging opening
8401 ramp
8402 charging ramp
840′ second charging opening
860 second heating device
861 second heating elements
861′ gas burner
862 gas burner
870 cleaning opening
870′ cleaning opening door
880 gas-circulation device
881 blower
Kₘₐₓ maximum filing level
kₘᵢₙ minimum filling level
1500 melting furnace
1501 molten metal
1501′ molten metal flow
1510 furnace chamber
1511 second furnace chamber
1511′ impurity collection chamber
1512 furnace wall
1512′ dividing wall
15121 inner region
1513 first connecting opening
1514 second connecting opening
1520 circulating device
1521 pump
1520′ second circulation device
1521 second pump
1530 first heating device
1531 immersion heating element
1540 first charging opening
1540′ second charging opening
1540″ Third third charging opening
1541 first charging opening door
1541′ second charging opening door
1541″ Third third charging opening door
1550 melt (car wheel rim)
1550′ melt (metal to be melted, e.g. metal bars)
1550″ melt (metal to be melted, e.g. metal shavings)
a areas with reduced flow cross-section
1700 melting furnace
1701 refractory lined side wall of furnace
1703 furnace housing
1702 flow arrow/flow direction
1710 ring channel
1711 inner wall
1712 straight section
1714 deflection area
1715 corner with chamfer
1720 circulating device
1730 heating device
1731 immersion heating element
1740 bottom weir
1742 connecting channel
1750 melting area for charging material
1752 inner region
1754 channel segment
1780 single module
1790 lid-lifting device
1792 inflow opening
1794 outflow opening
1796 lid
2000 connecting area
2010 flange area
2012 ring channel
2014 inner region
2016 circulating device
2018 immersion heating elements
2020 metal supply
2022 melt extraction
1-12 module

The invention is defined by the claims. The following aspects may be helpful for understanding the invention and form part of the present disclosure.
1. Melting furnace for melting metal, comprising:
   at least one charging opening for supplying metal to be melted;
   a first heating device with at least one electrically heatable immersion heating element; and
   a circulating device, which is configured to produce a molten metal flow inside the melting furnace, which circulates between the circulating device and the immersion heating element and flows past the charging opening.
2. Melting furnace according to aspect 1,
   comprising a ring channel (1710), which is an annular melt channel, wherein the heating device (130) and the circulating device (120) are arranged in the ring channel (1710) and/or wherein the ring channel (1710) is accessible through the charging opening (140).
3. Melting furnace (100) according to aspect 2,
   wherein the molten metal flow circulates through the ring channel (1710), in particular as an open trough flow.
4. Melting furnace (100) according to any one of the preceding aspects, wherein the melting furnace (100) has an accessible and/or free-flowing inner area (1752) which is circulated around by the ring channel (1710).
5. Melting furnace (100) according to any one of the preceding aspects, wherein the ring channel (1710) comprises a plurality of modules (1-12) through each of which the molten metal flow passes.
6. Melting furnace (100) according to aspect 5, wherein each module (1-12) has at least one inflow opening (1792) and at least one outflow opening (1794).
7. Melting furnace (100) according to aspect 5 or 6,
   wherein each module (1-12) is connected in a fluid-tight manner to at least two further modules (1-12) for transferring the molten metal flow between the modules (1-12).
8. Melting furnace (100) according to any one of the aspects 5 to 7, wherein each module (1-12) comprises a furnace housing which is lined with refractory material.
9. Melting furnace (100) according to any one of the aspects 5 to 8, wherein the following applies to the dimensions of at least a plurality of the modules (1-12):
   a height is less than or equal to 2.9 m or the height is less than or equal to 3.8 m; and/or
   at least one first horizontal dimension is less than or equal to 2.5 m or is less than or equal to 3 m; and/or
   at least one second horizontal dimension is less than or equal to 6 m or is less than or equal to 13.6 m.
10. Melting furnace (100) according to aspect 6, wherein the modules (1-12) have a connecting area at at least one inflow opening (1792) and/or at the at least one outflow opening (1794), by means of which they can be connected to any other module (1-12).
11. Melting furnace (100) according to any one of the preceding aspects, wherein the circulating device (120) comprises a mechanical or an electromagnetic pump (121) and the molten metal flow flows from a pressure side to a suction side of the pump (121) as part of its circulation.
12. Melting furnace (100) according to any one of the preceding aspects, wherein the heating device (130) is arranged in a portion of the ring channel (1710) in which a substantially complete volume exchange of the molten metal takes place as a result of the molten metal flow.
13. Melting furnace (100) according to any one of the preceding aspects, wherein the heating device (130) comprises a plurality of immersion heating elements (131), wherein each immersion heating element (131) is arranged at least partially outside a flow shadow of at least one corresponding other immersion heating element (131).
14. Melting furnace (100) according to any one of the preceding aspects, characterized in that the charging opening is positioned vertically above the molten metal flow and the molten metal flow can be generated in such a way that it flows against a charge material (250 or/and 350 and/or 450 and/or 550) supplied to the melting furnace (100) through the charging opening at a flow velocity.
15. Melting furnace (100) according to aspect 14,
   characterized in that the molten metal flow flows against at least a part of the supplied charge material at a flow velocity which corresponds to at least an average flow velocity, in particular at least twice the average flow velocity, of the molten metal flow during its circulation in the melting furnace (100).
16. Melting furnace (100) according to any one of the preceding aspects, further comprising at least one second heating device (660) which is positioned or can be positioned outside the molten metal (101) and which is configured to supply heat to the molten metal (101) and/or to a metal to be melted.
17. Melting furnace (100) according to aspect 16,
   wherein the second heating device (660) is electrically heatable and in particular is designed as a ceiling radiator and/or wherein the second heating device comprises at least one gas burner (861′).
18. Melting furnace (100) according to aspect 16 or 17,
   wherein the second heating device (660) is arranged vertically higher than the immersion heating element (131, 631) and/or wherein the second heating device (660) is arranged at least at the same vertical height or higher than a charging opening of a furnace chamber (611) with the second heating device (640).
19. Melting furnace (100) according to any one of the aspects 16 to 18, wherein the second heating device (660) and the first heating device (130, 630) are arranged in different furnace chambers (610, 611, 612, 612′).
20. Melting furnace (100) according to aspect 19,
   wherein the furnace chamber (611), in which the second heating device (660) is arranged, comprises a charging opening (640) for feeding metal to be melted.
21. Melting furnace (100) according to aspect 20,
   wherein an inflow area (614) of the furnace chamber (611), in which the second heating device (660) is arranged, is closer to the charging opening (640) than an outflow area of this furnace chamber (613).
22 Melting furnace (100) according to aspect 20 or 21,
   wherein the furnace chamber (610), in which the first heating device (630 or 130) is arranged, comprises a smaller dimensioned charging opening (140) than the charging opening (640) of the furnace chamber (611) in which the second heating device (660) is arranged.
23. Melting furnace (100) according to any one of the aspects 19 to 22, wherein the circulating device (120) is positioned close to an inflow area (614) of the furnace chamber (611) in which the second heating device (660) is arranged and/or opens into this inflow area, in particular wherein the circulating device (120) is, however, positioned outside the furnace chamber (611) which comprises the second heating device (660).
24. Melting furnace (100) according to any one of the aspects 16 to 23, wherein the molten metal flow can be generated in such a way that it flows from the first heating device (130 or 630) in the direction of the circulation device (120) and from the circulation device (120) in the direction of the second heating device (660).
25. Melting furnace (100) according to any one of the preceding aspects, wherein the melting furnace (100) has at least one impurity collecting chamber (811′″), through which the molten metal flow can flow, in which impurities contained in the molten metal (101) can be collected.
26. Melting furnace (100) according to aspect 25,
   wherein the impurity collecting chamber (811′″) has an inflow area and an outflow area and a bottom region (8112) which is lowered at least relative to the outflow area for collecting impurities deposited there, and/or
   wherein the inflow area has an opening cross-section which extends as far as a bottom region (8112) of a furnace chamber (811) which is arranged upstream of the impurity collecting chamber (811′″).
27 Melting furnace (100) according to any one of aspects 24 or 25,
   wherein the impurity collecting chamber (811′″) comprises an outflow valve which can be opened for an outflow of impurities deposited in the bottom region (8112).
28 Melting furnace (100) according to aspect 24,
   wherein the impurity collecting chamber (811′″) has an outflow area with an opening cross-section, wherein an upper edge of the opening cross-section is lower than a minimum permissible level (k-min) of the molten metal in a furnace chamber located upstream relative to the impurity collecting chamber (811′″), and
   wherein the inflow area has an opening cross-section whose upper edge is higher than a maximum permissible level (k-max) of the molten metal in the upstream furnace chamber.
29 Melting furnace (100) according to any one of the aspects 24 to 28, wherein the inflow area of the impurity collecting chamber (811′) is closer to a charging opening (140 and/or 240 and/or 340 and/or 440 and/or 540 and/or 540′ and or 640 and/or 740 and/or 740′) than the outflow area of the impurity collecting chamber (811′).
30. Melting furnace (100) with a first impurity collecting chamber (811′″) according to any one of aspects 16 to 17 and with a second impurity collecting chamber (811′″) according to aspect 18,
   wherein the first and second impurity collecting chambers (811′″) can be flowed through in succession by the molten metal flow.
31. Melting furnace (100) according to any one of the preceding aspects, further comprising a charging region (8402) which is positioned or can be positioned outside the molten metal (101) and is configured to receive metal to be melted.
32. The melting furnace (100) according to aspect 31, wherein the charging region (8402) is inclined.
33. Melting furnace (100) according to aspect 31,
   wherein the melting furnace (100) is configured to heat metal received in the charging region (8402), in particular by supplying heated air (881) from another region of the melting furnace (100) or by means of a gas burner (862) directed towards the charging region.
34 Melting furnace (100) according to any one of the preceding aspects, further comprising a region (a) with a flow cross-section reduction at least in some sections, which is located upstream of the charging opening (840).
35 Melting furnace (100) according to any one of the preceding aspects, with a lateral furnace pocket for filling the melting furnace (100) with molten metal.
36 Melting furnace (100) according to any one of the preceding aspects, with a control unit and a sensor which is configured to measure a level of the melt in the melting furnace and/or to detect melt at a specific vertical height in a chamber of the melting furnace and to transmit a signal relating thereto to the control unit.
37. Melting furnace (100) according to any one of the preceding aspects with aspect 2,
   with at least one bottom weir (1740) at a bottom of the ring channel (1710), wherein the bottom weir (1740) defines a height difference between regions of the ring channel (1710) adjoining the bottom weir (1740) on both sides, wherein the regions of the ring channel (1710) adjoining on both sides extend at an angle of more than 45° to one another, in particular of approximately 90°.
38. Melting furnace (100) according to aspect 37,
   wherein the bottom weir (1740) has a connecting channel (1742) which is located at a height level of the bottom of the neighboring regions of the ring channel (1710) and connects these regions to one another in a melt-conducting manner.
39. Melting furnace (100) according to any one of the preceding aspects, further comprising a lid (1796) and a lid-lifting device (1790), which is configured to lift the lid (1796) to make the ring channel (1710) accessible,
   in particular wherein the lid (1796) can be lifted substantially vertically and/or in a straight line, and wherein the lid-lifting device (1790) is arranged on a side of the melting furnace (100) facing the inner area (1752).
40. Melting furnace (100) according to any one of the preceding aspects, wherein the ring channel (1710) comprises at least one deflection area (1796) in which a flow direction of the molten metal flow is deflected by at least 45°,
   wherein the side wall sections of the ring channel (1710), which are arranged in flow direction upstream and downstream of the deflection area (1714), are rounded or merge into one another by means of a chamfer.
41. Melting furnace (100) for melting metal, comprising:
   at least one charging opening (140) for supplying metal to be melted;
   a molten metal (101) received in the melting furnace (100);
   a first heating device (130) with at least one electrically heatable immersion heating element (131);
   a circulating device (120), which is configured to produce a flow of molten metal flowing around the immersion heating element (131), wherein the flow of molten metal circulates between the circulating device (120) and the heating device (130) and flows past the charging opening (140).
42. Method for melting metal by means of a melting furnace (100) according to any one of the preceding aspects, wherein the method comprises:
   producing the molten metal flow by means of the circulating device (120), so that the molten metal flow flows around the immersion heating element (131) and circulates between the circulating device (120) and the heating device (130) and flows past the charging opening (140).
43. Method for producing a melting furnace (100) with a ring channel (1710), in which a molten metal can be circulated, comprising:
   connecting individual modules (1-12) forming at least one portion of the melting furnace (100), wherein each module (1-12) comprises a channel segment of the ring channel (1710) and an inflow opening (1792) and at least one outflow opening (1794).

1-20. (canceled)

21. A melting furnace for melting metal, comprising:
at least one charging opening for supplying metal to be melted;
a first heating device with at least one electrically heatable immersion heating element; and
a circulating device, which is configured to produce a molten metal flow inside the melting furnace, which circulates between the circulating device and the immersion heating element and flows past the charging opening, and
a ring channel, which is an annular melt channel for the molten metal flow,
wherein:
the heating device and the circulating device are arranged in the ring channel and/or wherein the ring channel is accessible through the charging opening,
characterized in that the melting furnace has a free inner area around which the ring channel extends, wherein the inner area has an area of at least 1 m².

22. The melting furnace according to claim 21, wherein the ring channel is configured to be circulated by the molten metal flow.

23. The melting furnace according to claim 21, wherein the inner area is accessible.

24. The melting furnace according to claim 21, wherein the ring channel has a plurality of modules through which the molten metal flow flows respectively.

25. The melting furnace according to claim 24, wherein:
the modules are arranged in succession and/or in a row along a flow direction of the molten metal; and/or
the modules form parts of the melting furnace that can be handled independently and/or transported independently and/or produced independently; and/or
each module is supported independently on a ground; and/or
each module comprises a section of the ring channel which is at least 0.5 m long.

26. The melting furnace according to claim 24, wherein each module has at least one inflow opening and at least one outflow opening.

27. The melting furnace according to claim 24, wherein each module is connected in a fluid-tight manner to at least two further modules for transferring the molten metal flow between the modules.

28. The melting furnace according to claim 24, wherein each module comprises a furnace housing, which is lined with a refractory material.

29. The melting furnace according to claim 24, wherein the following applies to the dimensions of at least a plurality of modules:
a height is less than or equal to 2.9 m or the height is less than or equal to 3.8 m; and/or
at least one first horizontal dimension is less than or equal to 2.5 m or is less than or equal to 3 m; and/or
at least one second horizontal dimension is less than or equal to 6 m or is less than or equal to 13.6 m.

30. The melting furnace according to claim 26, wherein the modules have a connecting area at at least one inflow opening and/or at at least one outflow opening by means of which they can be connected to any other module.

31. The melting furnace according to claim 20, wherein the heating device comprises a plurality of immersion heating elements, wherein each immersion heating element is arranged at least partly outside a flow shadow of at least one corresponding other immersion heating element.

32. The melting furnace according to claim 20, characterized in that the charging opening is positioned vertically above the molten metal flow and the molten metal flow can be produced such that it flows against a charging material supplied to the melting furnace through the charging opening at a flow velocity.

33. The melting furnace according to claim 20, further comprising at least one second heating device, which is positioned or can be positioned outside the molten metal and which is e configured to supply heat to the molten metal and/or a metal to be melted.

34. The melting furnace according to claim 33, wherein the second heating device is configured to be electrically heatable.

35. The melting furnace according to claim 33, wherein the second heating device and the first heating device are arranged in different furnace chambers.

36. The melting furnace according to claim 35, wherein the furnace chamber, in which the second heating device is arranged, comprises a charging opening for supplying metal to be melted.

37. The melting furnace according to claim 36, wherein the furnace chamber, in which the first heating device is arranged, comprises a smaller sized charging opening, than the charging opening of the furnace chamber, in which the second heating device is arranged.

38. The melting furnace according to claim 35,
wherein the circulating device is positioned close to an inflow area of the furnace chamber, in which the second heating device is arranged, and/or opens into this inflow area.

39. The melting furnace according claim 20,
further comprising a lid and a lid-lifting device, which is configured to lift the lid for making the ring channel accessible.

40. A method for producing a melting furnace with a ring channel, in which a molten metal can be circulated, comprising:
connecting individual modules to form at least one portion of the melting furnace and so that the melting furnace has a free inner area which the ring channel extends around, wherein each module comprises a channel segment of the ring channel and an inflow opening and at least one outflow opening, wherein the inner area has an area of at least 1 m².
